(19) United States
(12) Patent Application Publication
(10) Pub. No.: US 2011/0050795 A1
(43) Pub. Date: Mar. 3, 2011

(54) INK SET AND IMAGE FORMATION METHOD

(75) Inventors: Yoshimitsu ARAI, Kanagawa (JP); Kaoru TOJO, Kanagawa (JP); Mika IMAMURA, Kanagawa (JP)

(73) Assignee: FUJIFILM CORPORATION, Tokyo (JP)

(21) Appl. No.: 12/868,754

(22) Filed: Aug. 26, 2010

(30) Foreign Application Priority Data
Sep. 2, 2009 (JP) 2009-203045

(51) Int. Cl. B41J 2/165; C08K 5/21; C08K 5/3415

(52) U.S. Cl. 347/28; 524/211; 524/104

(57) ABSTRACT

The present invention provides an ink set including an ink composition and a maintenance liquid, wherein the ink composition includes a pigment, polymer particles having a glass transition temperature (Tg) of 50° C. or higher, and at least one of urea or a urea derivative.

### CROSS-REFERENCE TO RELATED APPLICATION

This application claims priority under 35 USC 119 from Japanese Patent Application No. 2009-203045 filed on Sep. 2, 2009, the disclosure of which is incorporated by reference herein.

### BACKGROUND OF THE INVENTION

1. Field of the Invention

The invention relates to an ink set and an image formation method. Specifically, the invention relates to an ink set including an ink composition and a maintenance liquid, and an image formation method.

2. Description of the Related Art

Following rapid progress in the field of information technology in recent years, different types of information processing systems have been developed and recording methods and recording devices suitable for each information processing system have been put to practical use. Among these, inkjet recording methods are widely used because of advantages in that recording is possible on various types of recording media, the hardware (devices) are comparatively inexpensive and compact, and a very low level of noise is generated. Furthermore, with respect to recording using the inkjet recording method, a high quality recorded matter of so-called “photo-like” quality can be obtained.

In general, inkjet recording methods that use a pigment-based ink have better stability than inkjet recording methods that use a dye-based ink.

However, when moisture in a pigment-based ink evaporates and the pigment-based ink solidifies, the pigment ink left as a solid is not re-dissolved. As a result, a nozzle end portion of an inkjet head or like may become clogged, which may cause non-ejection of ink. Further, if ink solidifies at a cap or a wiping portion or the like, wiping may become difficult, which lead to a problem of increase in maintenance burdens.

For the above-described problems, a maintenance liquid for inkjet recording has been disclosed which contains from 0.1% by mass to 10% by mass of a resin solvent having a solubility in water at 25° C. of 3% by mass or more, and from 1% by mass to 50% by mass of a wetting agent (see, for example, Japanese Patent Application Laid-Open (JP-A) No. 2007-119658).

Further, an ink composition has been disclosed which contains a pigment, resin emulsion particles having the lowest film forming temperature of 20° C. or lower, urea, a sugar or sugar derivative, a water-soluble organic solvent, and water (see, for example, Japanese Patent No. 3770011). It has been disclosed that a resin emulsion having a glass transition temperature (Tg) of 10° C. or lower is preferable from the viewpoint of the film formability of forming a transparent continuous film. It has been disclosed that the ink composition has good rubbing resistance and quick drying property, and is excellent in jetting stability.

However, with respect to the ink composition of JP-A No. 2007-119658, when the addition amount of the resin particles is increased in order to improve the fixability to the recording medium, it sometimes becomes difficult to wipe off the ink composition (inferior maintenanceability). This tendency is greater, for example, when the ink composition is dried and solidified around the nozzles or the like. With respect to the ink composition of Japanese Patent No. 3770011, it has been found that the printed matters tend to adhere to each other when they are stacked (which is a defect called “blocking”), and that the image quality is significantly lowered when high-speed printing is carried out. It has also been found that the accuracy of the landing position of the jetted ink is significantly lowered when continuous printing is repeatedly carried out.

The invention has been made in view of the above.

### SUMMARY OF THE INVENTION

One embodiment of the invention is an ink set including an ink composition and a maintenance liquid, the ink composition including a pigment, polymer particles having a glass transition temperature (Tg) of 50° C. or higher, and at least one of urea or a urea derivative.

### DETAILED DESCRIPTION OF THE INVENTION

Hereinafter, embodiments of the invention are described in more detail.

<1> An ink set including an ink composition and a maintenance liquid, the ink composition including a pigment, polymer particles having a glass transition temperature (Tg) of 50° C. or higher, and at least one of urea or a urea derivative.
<2> The ink set of <1>, wherein the pigment is coated with a water-insoluble resin by a phase inversion emulsification method.
<3> The ink set of <1> or <2>, wherein the polymer particles are self-dispersible polymer particles.
<4> The ink set according to any one of <1> to <3>, wherein the polymer particles have a glass transition temperature (Tg) of from 50° C. to 200° C.
<5> The ink set of <2>, wherein a solid content mass ratio of the pigment with respect to a total mass of the water-insoluble resin and the polymer particles (the pigment/(the water-insoluble resin+the polymer particles) in the ink composition) is 1 or less.
<6> The ink set of <3>, wherein the self-dispersible polymer particles include a water-insoluble polymer including a hydrophilic structural unit, and, as a hydrophobic structural unit, a structural unit derived from an aromatic group-containing monomer.
<7> The ink set of <6>, wherein the hydrophilic structural unit of the water-insoluble polymer is derived from a hydrophilic group-containing monomer, wherein the hydrophilic group is a dissociating group.
<8> The ink set according to any one of <1> to <7>, wherein the ink composition further includes a water-soluble organic solvent and water, and 70% by mass or more of the water-soluble organic solvent is a water-soluble organic solvent having an SP value of 27.5 or less.
<9> The ink set of <8>, wherein the water-soluble organic solvent added to the ink composition is selected from alkanediols or polyhydric alcohols, alkyl alcohols having 1-4 carbon atoms, glycol ethers, alkylene oxide adducts of glycerol, 2-pyrrolidone, N-methyl-2-pyrrolidone, 1,3-dimethyl-2-imidazolizinone, formamide, acetamide, dimethylsulfoxide, sorbit, sorbitan, acetin, diacetin, triacetin, or sulfolane.
<10> The ink set according to any one of <1> to <9>, wherein a total content of the urea and the urea derivative in the ink composition is from 1.0% by mass to less than 20.0% by mass.
<11> The ink set according to any one of <1> to <10>, wherein the maintenance liquid includes a water-soluble organic solvent and water, and 50% by mass or more of the water-soluble organic solvent is a water-soluble organic solvent having an SP value of 27.5 or less.
<12> The ink set of <11>, wherein the water-soluble organic solvent added to the maintenance liquid is selected from alkanediols or polyhydric alcohols, alkyl alcohols having 1-4 carbon atoms, glycol ethers, alkylene oxide adducts of glycerol, 2-pyrrolidone, N-methyl-2-pyrrolidone, 1,3-dimethyl-2-imidazolizinone, formamide, acetamide, dimethylsulfoxide, sorbit, sorbitan, acetin, diacetin, triacetin, or sulfolane.
<13> The ink set according to any one of <1> to <12>, wherein the maintenance liquid further includes a surfactant.
<14> The ink set according to any one of <1> to <13>, further including an aggregation liquid including an aggregating agent that aggregates components in the ink composition.
<15> An image formation method including:

providing the ink set according to any one of <1> to <14>;

jetting the ink composition from an inkjet head to apply the ink composition to a recording medium; and

removing the ink composition adhering to the inkjet head with the maintenance liquid.

<16> The image formation method of <15>, further including applying an aggregation liquid to the recording medium, wherein the aggregation liquid includes an aggregating agent that aggregates components in the ink composition.

### 1. Ink Composition

The ink composition used in the invention contains at least a pigment, polymer particles having a glass transition temperature (Tg) of 50° C. or higher, and urea or a urea derivative.

By using the combination of an ink composition including the above-described components and a maintenance liquid described later, the rubbing resistance, the jetting stability, the high-speed printing suitability, and the anti-blocking property may be improved.

Hereinafter, respective components contained in the ink composition used in the invention are specifically described.

Pigment

The ink composition used in the invention contains at least one pigment.

The pigment used in the invention is not specifically limited, and may be appropriately selected depending on the purposes. For example, the pigment may be either an organic pigment or an inorganic pigment, or both of these can be used in combination.

Examples of the organic pigment include azo pigments, polycyclic pigments, dye chelates, nitro pigments, nitroso pigments and aniline black. In particular, azo pigments and polycyclic pigments are preferable.

Examples of the azo pigments include an azo lake pigment, an insoluble azo pigment, a condensed azo pigment, and a chelate azo pigment.

Examples of the polycyclic pigments include a phthalocyanine pigment, a perylene pigment, a perynone pigment, an anthraquinone pigment, a quinacridone pigment, a dioxazine pigment, an indigo pigment, a thioindigo pigment, an isoindolinone pigment, and a quinofraron pigment.

Examples of the dye chelates include basic dye chelate pigments and acid dye chelate pigments.

Examples of the inorganic pigments include titanium oxide, iron oxide, calcium carbonate, barium sulfate, aluminum hydroxide, barium yellow, cadmium red, chrome yellow, and carbon black. Among these pigments, carbon black is particularly preferable. The carbon black may be, for example, a carbon black manufactured by a known method such as a contact method, a furnace method or a thermal method.

The pigment may be used singly or in combination of two or more thereof, each of which may be selected from the above classes of pigments and may belong to the same class as each other or different classes from each other.

The pigment used in the present invention is preferably used as water dispersions of at least one pigment selected from the following (1) to (4), from the viewpoint of liquid stability and ejection stability.

(1) An encapsulated pigment: a polymer emulsion of a pigment embedded in each water-insoluble resin fine particle; more specifically, water dispersions of pigment particles each coated with a hydrophilic water-insoluble resin so as to impart hydrophilic properties to the surface of the pigment particle.

(2) A self-dispersible pigment: a pigment having at least one hydrophilic group on a surface thereof and exhibiting at least one of water-dispersibility or water-solubility in the absence of a dispersant; more specifically, a pigment prepared by subjecting the surfaces of pigment particles (such as carbon black particles) to an oxidizing treatment so as to impart hydrophilic properties to the pigment particles and so as to enable the pigment itself to disperse in water.

(3) A resin dispersed pigment: a pigment dispersed using a water-soluble polymer compound having a weight average molecular weight of 50,000 or less.

(4) A surfactant-dispersed pigment: a pigment dispersed using a surfactant.

Among these pigments, the encapsulated pigment (1), the self-dispersible pigment (2) and the resin dispersed pigment (3) are preferable, and the encapsulated pigment (1) and the resin dispersed pigment (3) are particularly preferable.

Ratio of Pigment Dispersant to Pigment

The ratio (mass ratio) of a content of a pigment dispersant to a content of a pigment (pigment dispersant/pigment) in the ink composition is preferably from 25/100 to 140/100, and more preferably from 25/100 to 50/100. When the ratio is 25/100 or more, the dispersion stability and rub resistance may tend to be improved. When the content ratio is 140/100 or less, the dispersion stability may tend to be improved as well.

From the viewpoint of coloring property, granularity, ink stability, and ejection reliability, the content of pigment in a total ink composition used in the present invention is preferably from 0.1% by mass to 15% by mass, more preferably from 0.5% by mass to 12% by mass, and further preferably from 1% by mass to 10% by mass.

Encapsulated Pigment

The encapsulated pigment is described in detail.

The resin used in the encapsulated pigment is not specifically limited. As the resin, however, it is preferable to use a hydrophilic and water-insoluble polymer compound that is self-dispersible or dissolvable in a mixed solvent of water and a water-soluble organic solvent and that has an anionic (acidic) group. In general, the number average molecular weight of the resin is preferably in the range of about 1,000 to about 100,000, and particularly preferably in the range of about 3,000 to about 50,000. The resin is preferably a resin that can dissolve in an organic solvent to form a solution. When the number average molecular weight of a resin is within the above ranges, the resin can exhibit sufficient function as a cover layer on pigment particles or as a coated layer of an ink composition. The resin is preferably used in the form of an alkali metal salt or an organic amine salt.

The resin used for the encapsulated pigment may be, for example, a material having an anionic group, and examples thereof include thermoplastic, thermosetting, or modified resins that are composed of the following types of resin: a polymer compound such as an acrylic resin, an epoxy resin, a polyurethane resin, a polyether resin, a polyamide resin, an unsaturated polyester resin, a phenol resin, a silicone resin, or a fluorine resin; a polyvinyl resin such as polyvinyl chloride, polyvinyl acetate, polyvinyl alcohol or polyvinyl butyral; a polyester resin such as an alkyd resin or a phthalic acid resin; an amino resin such as a melamine resin, a melamine-formaldehyde resin, an amino alkid co-condensed resin, a urea formaldehyde resin, or a urea resin; and copolymers or mixtures of two or more of these resins.

Of the above resins, an anionic acrylic resin can be obtained, for example, by polymerizing, in a solvent, an acrylic monomer having an anionic group (hereinafter, referred to as an anionic group-containing acrylic monomer) and, optionally, one or more other monomers copolymerizable with the anionic group-containing acrylic monomer. Examples of the anionic group-containing acrylic monomer include an acrylic monomer having one or more anionic groups selected from the group consisting of a carboxylic group, a sulfonic acid group and a phosphonic group. Among these acrylic monomers, an acrylic monomer having a carboxyl group is especially preferable.

Examples of the acrylic monomer having a carboxyl group include acrylic acid, methacrylic acid, crotonic acid, ethacrylic acid, propylacrylic acid, isopropylacrylic acid, itaconic acid and fumaric acid. Among these monomers, acrylic acid and methacrylic acid are preferable.

An encapsulated pigment can be manufactured by a conventional physical and/or chemical method by using the above components. According to a preferable embodiment of the present invention, the encapsulated pigment can be manufactured by the methods described in JP-A Nos. 9-151342, 10-140065, 11-209672, 11-172180, 10-25440, or 11-43636.

Specifically, examples of the method for manufacturing the encapsulated pigment include a phase-inversion emulsification method and an acid precipitation method described in JP-A Nos. 9-151342 and 10-140065.

The phase-inversion emulsification method is a self-dispersion (phase-inversion emulsification) method, which may basically include a process of dispersing a fused mixture of a self-dispersible or water-soluble resin and a pigment in water. The fused mixture may contain the above-described curing agent or polymer compound as a component thereof. The “fused mixture” refers to a state in which undissolved components are mixed, or a state in which dissolved components are mixed, or a state including both of the above states. Specific examples of the phase-inversion method include that described in JP-A No. 10-140065.

For more detailed information about the phase-inversion emulsification method and the acid precipitation method, JP-A Nos. 9-151342 and 10-140065 can be referred to.

Water-Insoluble Resin

The water-insoluble resin used as a pigment dispersant in the present invention is preferably a hydrophilic and water-insoluble resin having a hydrophilic structural unit (a) and a hydrophobic structural unit (b). The water-insoluble resin may further have another structural unit which is different from the hydrophilic structural unit (a) and the hydrophobic structural unit (b) in accordance with necessity.

Hydrophilic Structural Unit (a)

There is no particular limitation on the hydrophilic structural unit (a) insofar as it is derived from a hydrophilic group-containing monomer, and may be derived from one hydrophilic group-containing monomer or may be derived from two or more hydrophilic group-containing monomers. The hydrophilic group is not particularly limited and may be a dissociating group or a nonionic hydrophilic group.

The dissociating group and/or a nonionic hydrophilic group may be incorporated into the water-insoluble resin used in the present invention, by using a monomer having a dissociating group (a dissociating group-containing monomer) and/or a monomer having a nonionic hydrophilic group.

The dissociating group may be preferable from the viewpoints of stabilizing the emulsion state or the dispersion state. Examples of the dissociating group include a carboxyl group, a phosphoric acid group, and a sulfonic acid group. Among these groups, the carboxyl group is preferable from the viewpoint of the dispersion stabilizing property when the ink composition is formed therewith.

The hydrophilic group-containing monomer is preferably a dissociating group-containing monomer, and specifically, the hydrophilic group-containing monomer is preferably a dissociating group-containing monomer having a dissociating group and an ethylenically unsaturated bond. Examples of the dissociating group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methylsuccinic acid. Specific examples of the unsaturated sulfonic acid monomer include styrene sulfonic acid, 2-acrylamido-2-methyl propane sulfonic acid, 3-sulfopropyl (meth)acrylate, and bis-(3-sulfopropyl)-itaconic acid ester. Specific examples of the unsaturated phosphoric acid monomer include vinyl phosphoric acid, vinyl phosphate, bis(methacryloxyethyl) phosphate, diphenyl-2-acryloyloxyethyl phosphate, diphenyl-2-methacryloyloxyethyl phosphate, and dibutyl-2-acryloyloxyethyl phosphate.

Among these dissociating group-containing monomers, the unsaturated carboxylic acid monomer is preferable, and acrylic acid and methacrylic acid are more preferable, from the viewpoints of dispersion stability and ejection stability. Accordingly, the hydrophilic structural unit (a) preferably includes a structural unit derived from (meth)acrylic acid.

Examples of the hydrophilic structural unit (a) further include a structural unit derived from a monomer having a nonionic hydrophilic group. The monomer forming a structural unit having a nonionic hydrophilic group is not particularly limited as long as it has both a nonionic hydrophilic functional group and a functional group (for example, an ethylenically unsaturated bond) that can form a polymer, and may be selected from monomers known in the art. Vinyl monomers are preferable from the viewpoints of availability, ease in handling and general versatility.

Examples of the hydrophilic structural unit (a) include hydrophilic functional group-containing vinyl monomers such as hydrophilic functional group-containing (meth)acrylates, hydrophilic functional group-containing (meth)acrylamides, or hydrophilic functional group-containing vinyl esters.

Examples of the “hydrophilic functional group” as used herein include a hydroxyl group, an amino group, an amide group (in which nitrogen atom is unsubstituted), and alkylene oxides such as polyethylene oxide or polypropylene oxide described below.

Preferable examples of the hydrophilic structural unit (a) include hydroxyethyl (meth)acrylate, hydroxybutyl (meth)acrylate, (meth)acrylamide, aminoethyl acrylate, aminopropyl acrylate, and alkylene oxide polymer-containing (meth)acrylates.

The hydrophilic structural unit having a nonionic hydrophilic group may be incorporated into the water-insoluble resin by forming a polymer chain of the water-insoluble resin by polymerizing monomers corresponding to the hydrophilic structural unit. Alternatively, the hydrophilic structural unit having a nonionic hydrophilic group may be provided in the water-insoluble resin by introducing a hydrophilic functional group into a polymer chain of the water-insoluble resin which has been formed by polymerization.

The hydrophilic structural unit having a nonionic hydrophilic group is more preferably a hydrophilic structural unit having an alkylene oxide structure. From the viewpoint of hydrophilicity, the alkylene moiety of the alkylene oxide structure preferably has 1 to 6 carbon atoms, more preferably has 2 to 6 carbon atoms, and still more preferably has 2 to 4 carbon atoms. The degree of polymerization of the alkylene oxide structure is preferably 1 to 120, more preferably 1 to 60, and still more preferably 1 to 30.

In one preferable embodiment, the hydrophilic structural unit having a nonionic hydrophilic group is a hydroxyl group-containing hydrophilic functional unit. The number of a hydroxyl group(s) in the structural unit, although being not particularly limited, is preferably 1 to 4, more preferably 1 to 3, and still more preferably 1 to 2, from the viewpoints of the hydrophilicity of the water-insoluble resin and compatibility with a solvent and other monomers at the time of polymerization.

For example, the content ratio of the hydrophilic structural unit may vary depending on the content ratio of the hydrophobic structural unit (b) described below. For example, when the water-insoluble resin is composed exclusively of acrylic acid and/or methacrylic acid (hydrophilic structural unit (a)) and the hydrophobic structural unit (b) described below, the content ratio of acrylic acid and/or methacrylic acid may be determined by “100−(the hydrophobic structural unit) (mass %)”.

The hydrophilic structural units (a) may be used singly or as a mixture of two or more thereof.

The content ratio of the hydrophilic structural unit (a) is preferably in the range of from more than 0% by mass to 15% by mass, more preferably in the range of 2% by mass to 15% by mass, still more preferably in the range of 5% by mass to 15% by mass, and further more preferably in the range of 8% by mass to 12% by mass, with respect to the total amount of the water-insoluble resin.

Hydrophobic Structural Unit (b)

The hydrophobic structural unit (b) preferably includes a structural unit including an aromatic ring which is linked to, through a linking group, an atom which configures a main chain structure of the water-insoluble resin.

The hydrophobic structural unit including the aromatic ring maintains an adequate distance between the aromatic ring, which is hydrophobic, and a hydrophilic structural unit in the water-insoluble resin because the aromatic ring is linked to, through a linking group, an atom which configures a main chain structure of the water-insoluble resin, so that the aromatic ring is not directly linked to the an atom which configures a main chain structure of the water-insoluble resin. Therefore, an interaction between the water-insoluble resin and the pigment can easily occur, whereby the water-insoluble resin can be firmly adsorbed to the pigment, so that the dispersibility of the pigment can be improved.

Among the structural unit including an aromatic ring which is linked to, through a linking group, an atom which configures a main chain structure of the water-insoluble resin, a structural unit represented by the following Formula (2) is preferable from the viewpoint of facilitating easy granulation of the pigment.

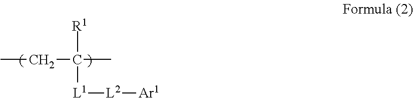

In Formula (2), R¹ represents a hydrogen atom, a methyl group or a halogen atom; L¹ represents *—COO—, *—COO—, *—CONR²—, *—O—, or a substituted or unsubstituted phenylene group wherein the bond designated by “*” in each structure corresponds to the bond linked to the main chain of the water-insoluble resin; and R² represents a hydrogen atom or an alkyl group having 1 to 10 carbon atoms. Here, examples of the substituent which the phenylene group may have include, but are not limited to, a halogen atom, an alkyl group, an alkoxy group, a hydroxyl group, and a cyano group.

L² represents a single bond or a divalent linking group having 1 to 30 carbon atoms. If L² represents a divalent linking group, the linking group preferably has 1 to 25 carbon atoms, more preferably has 1 to 20 carbon atoms, and still more preferably has 1 to 15 carbon atoms. Particularly preferably, L² represents an alkyleneoxy group having 1 to 25 carbon atoms (more preferably 1 to 10 carbon atoms), an imoino group (—NH—), a sulfamoyl group, a divalent linking group containing an alkylene group such as an alkylene group having 1 to 20 carbon atoms (more preferably 1 to 15 carbon atoms) or ethyleneoxide group (—(CH₂CH₂O)ₙ—, in which n is an integer of from 1 to 6), and a group containing two or more of these in combination.

In Formula (2), Ar¹ represents a monovalent group derived from an aromatic ring. The aromatic ring represented by Ar¹ is not particularly limited, and examples thereof include a benzene ring, a condensed aromatic ring having 8 or more carbon atoms, a heterocyclic ring condensed with an aromatic ring, and connected benzene rings in which two or more benzene rings are connected. Details of the condensed aromatic ring having 8 or more carbon atoms and a heterocyclic ring condensed with an aromatic ring are the same as the already-described ones.

Among the structural units represented by Formula (2), it is a preferable combination that R¹ represents a hydrogen atom or a methyl group, L¹ represents *—COO—, and L² represents a divalent linking group having 1 to 25 carbon atoms and containing an alkyleneoxy group and/or an alkylene group. As a more preferable combination, R¹ represents a hydrogen atom or a methyl group, L¹ represents *—COO—, and L² represents *—(CH₂—CH₂—O)ₙ— (where n represents an average of numbers of repeating units and is from 1 to 6).

The condensed aromatic ring having 8 or more carbon atoms is an aromatic compound having 8 or more carbon atoms and containing: an aromatic ring formed by condensation of two or more benzene rings; and/or a ring formed by at least one aromatic ring and an alicyclic hydrocarbon condensed with the aromatic ring. Specific examples thereof include naphthalene, anthracene, fluorene, phenanthrene, and acenaphthene.

The heterocyclic ring condensed with an aromatic ring refers to a compound in which an aromatic compound (preferably a benzene ring) containing no hetero atom and a cyclic compound containing a hetero atom are condensed with each other. Here, the cyclic compound containing a hetero atom is preferably a 5-membered ring or a 6-membered ring. Preferable examples of the hetero atom include a nitrogen atom, an oxygen atom, and a sulfur atom. The cyclic compound containing a hetero atom may contain plural hetero atoms, and in this case, the hetero atoms may be the same or different from each other. Specific examples of the heterocyclic ring condensed with an aromatic ring include phthalimide, acridone, carbazole, benzoxazole, and benzothiazole.

Specific examples of a monomer that can form the structural unit represented by Formula (2) are shown below, although the invention is not restricted to the following examples.

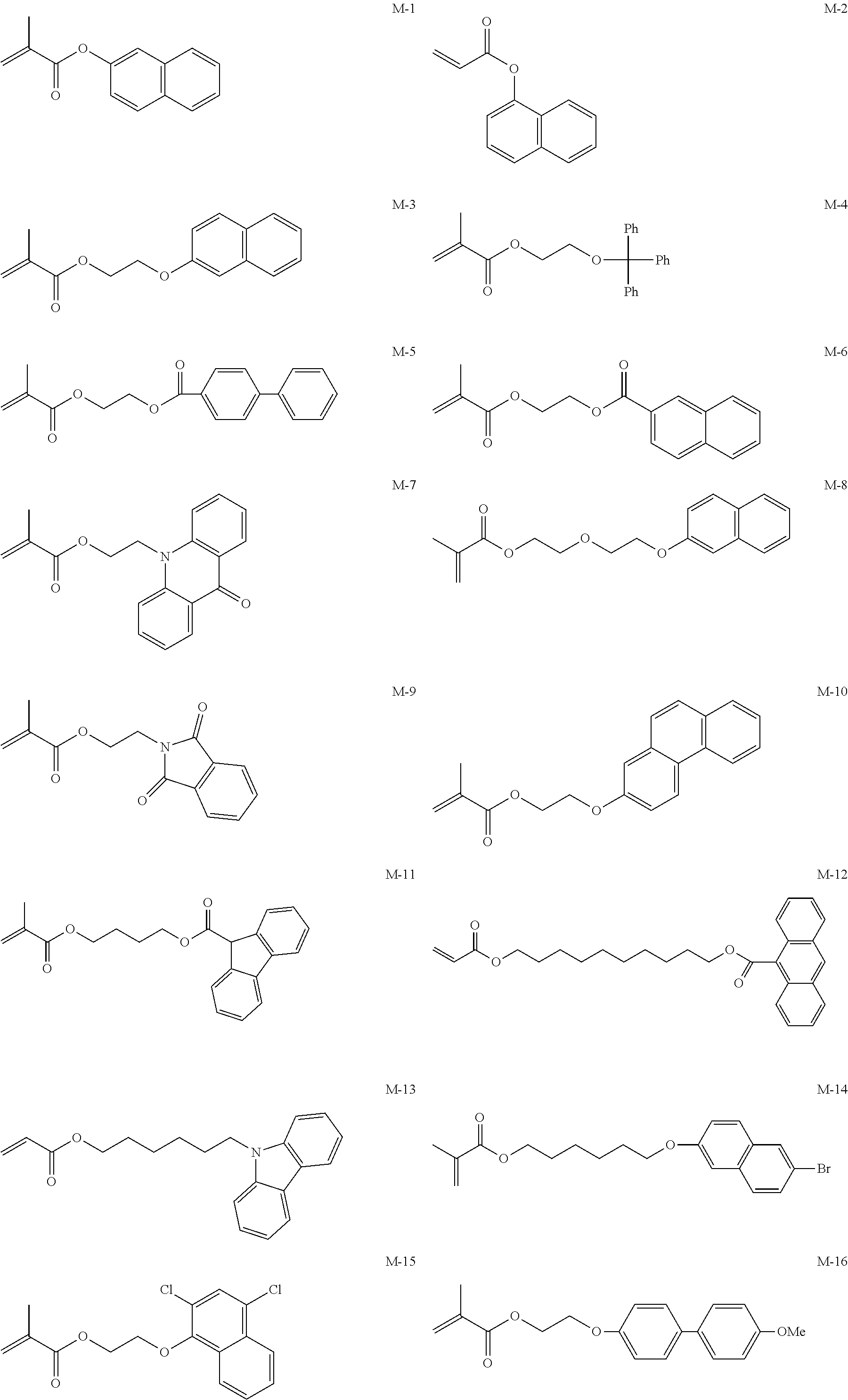

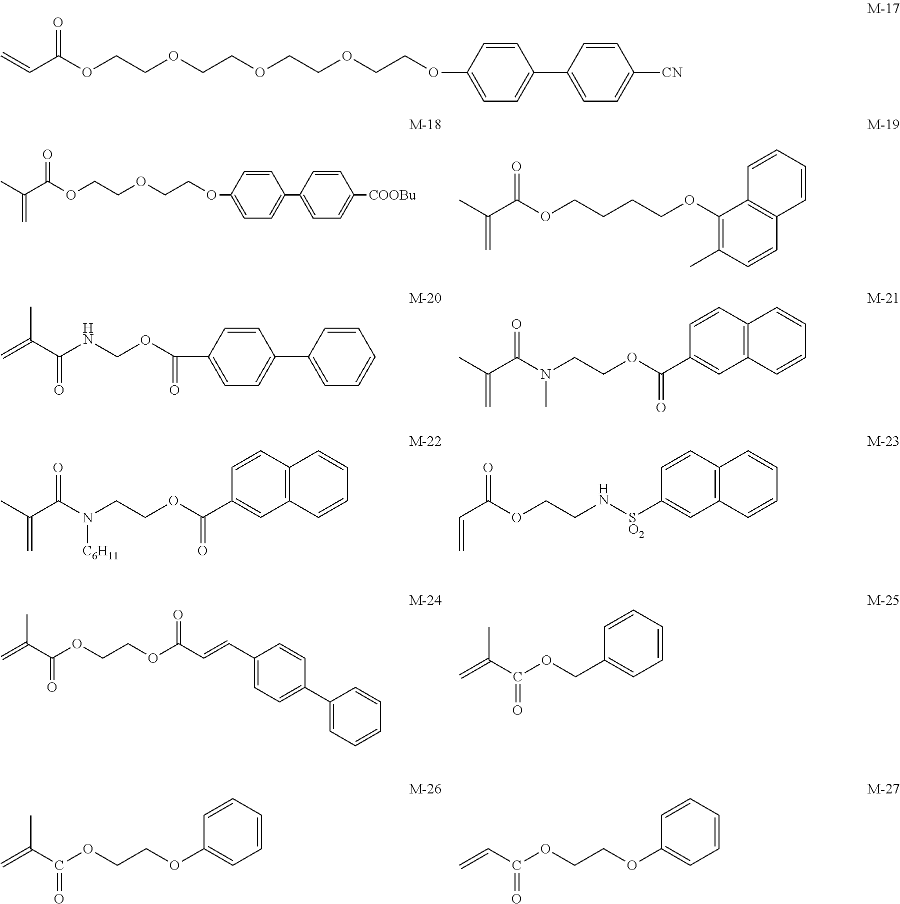

Among the structural units represented by Formula (2), structural unit derived from a compound selected from the group consisting of benzyl methacrylate, phenoxyethyl acrylate and phenoxyethyl methacrylate may be preferable in consideration of the dispersion stability. In preferable embodiments, the water-insoluble resin contains one or more of the structural units selected from these as the hydrophobic structural unit (b).

The content of the structural unit having an aromatic ring which is linked to, through a linking group, an atom which configures the main chain of the water-insoluble resin is preferably 40% by mass or more, more preferably from 40% by mass to less than 75% by mass, still more preferably from 40% by mass to less than 70% by mass, and particularly preferably from 40% by mass to less than 60% by mass, with respect to the total amount of the water-insoluble resin, in consideration of dispersion stability of the pigment and ejection stability and detergent property of the ink composition.

The content of the aromatic ring which is linked to, through a linking group, an atom which configures the main chain of the water-insoluble resin is preferably from 15% by mass to 27% by mass, more preferably from 15% by mass to 25% by mass, and particularly preferably from 15% by mass to 20% by mass, with respect to the total amount of the water-insoluble resin, from the viewpoint of improving rubbing resistance. When the content of the aromatic ring is in the above ranges, rubbing resistance, ink stability and ink ejection reliability may be enhanced.

From the viewpoint of dispersion stability, the hydrophobic structural unit (b) preferably has a structural unit derived from an alkyl (meth)acrylate having 1 to 4 carbon atoms in its alkyl group (a (meth)acrylic acid ester of an alkyl having 1 to 4 carbon atoms). The scope of “(meth)acrylic acid” include acrylic acid and methacrylic acid

Specific examples of the alkyl (meth)acrylate include methyl (meth)acrylate, ethyl (meth)acrylate, (iso)propyl (meth)acrylate, and (iso- or tertiary-) butyl (meth)acrylate. The number of carbon atoms in the alkyl moiety of the alkyl ester is in the range of from 1 to 4, and is preferably 1 or 2.

From the viewpoint of dispersion stability, the content ratio of the “structural unit derived from an alkyl (meth)acrylate having 1 to 4 carbon atoms” in the water-insoluble resin is preferably 15% by mass or more with respect to the total amount of the water-insoluble resin. The content ratio of this structural unit is preferably from 20% by mass to 60% by mass, more preferably from 20% by mass to 50% by mass.

As mentioned above, from the viewpoint of further increasing the dispersion stability, the hydrophobic structural unit (b) contains preferably the structural unit having an aromatic ring bonded to an atom for forming the main chain through a linking group in an amount of 40% by mass or more (more preferably from 40% by mass to 75% by mass, further more preferably from 40% by mass to 70% by mass, particularly preferably from 40% by mass to 60% by mass) with respect to the total mass of the water-insoluble resin, and the structural unit derived from an alkyl ester having 1-4 carbon atoms of (meth)acrylic acid in an amount of 15% by mass or more (more preferably from 20% by mass to 60% by mass, particularly preferably from 20% by mass to 50% by mass) with respect to the total mass of the water-insoluble resin.

Examples of the hydrophobic structural unit (b) other than those described above include structural units which do not belong to the hydrophilic structural unit (a) (for example, structural units which do not have a hydrophilic functional group) and which are derived from vinyl monomers such as (meth)acrylamides, styrenes or vinyl esters, and (meth)acrylates such as alkyl esters (number of carbon atoms: 1 to 4) of (meth)acrylic acid. These structural units may be used singly or as a mixture of two or more thereof.

Examples of the (meth)acrylamides include N-cyclohexyl (meth)acrylamide, N-(2-methoxyethyl) (meth)acrylamide, N,N-diallyl (meth)acrylamide and N-allyl (meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, and chloromethylstyrene; hydroxystyrene protected by a group (for example, t-Boc) that can be deprotected by an acidic material; methyl vinylbenzoate, α-methylstyrene, and vinyl naphthalene. Among them, styrene and α-methylstyrene are preferable.

Examples of the vinyl esters include vinyl acetate, vinyl chloroacetate, vinyl propionate, vinyl butyrate, vinyl methoxyacetate, and vinyl benzoate. Among them, vinyl acetate is preferable.

Examples of the (meth)acrylates include methyl (meth)acrylate, ethyl (meth)acrylate, (iso)propyl (meth)acrylate, and (iso- or tertiary-) butyl (meth)acrylate.

With respect to the composition of the hydrophilic structural unit (a) and the hydrophobic structural unit (b), the content of the hydrophobic structural unit (b), although varying depending on the degrees of the hydrophilicity and hydrophobicity of these units, is preferably higher than 80% by mass, more preferably higher than 85% by mass, with respect to the total amount of the water-insoluble resin. In other words, the content of the hydrophilic structural unit (a) is preferably in the range of 15% by mass or less, with respect to the total amount of the water-insoluble rein. When the content of the hydrophilic structural unit (a) is 15% by mass or less, the component which is dissolved by itself in an aqueous medium without contributing to dispersion of the pigment is reduced. Therefore, the dispersed state of the pigment can be kept excellent, and the viscosity can be suppressed from increasing, and thus the water-insoluble resin when used in an ink for inkjet recording can improve ejection performance.

The water-insoluble resin used in the present invention may be a random copolymer in which the respective structural units are randomly introduced or a block copolymer in which the respective structural units are regularly introduced. When the water-insoluble resin is a block copolymer, the order of introducing the respective structural units during the synthesis of the block polymer is not limited; further, the same structural unit may be used two or more times during the synthesis of the block copolymer. The water-insoluble resin is preferably a random copolymer in consideration of the versatility and manufacturability.

The acid value of the water-insoluble resin used in the present invention is preferably 100 mg KOH/g or less, more preferably from 30 mg KOH/g to 100 mg KOH/g, further preferably from 30 mg KOH/g to 85 mg KOH/g, and particularly preferably from 50 mg KOH/g or more to 85 mg KOH/g, in consideration of the pigment dispersibility and storage stability.

Here, the acid value is defined as the mass (mg) of KOH required for completely neutralizing 1 g of the water-insoluble resin, and can be measured in accordance with the method described in JIS Standard (JIS-K0070 (1992); the disclosure of which is incorporated by reference herein).

The molecular weight of the water-insoluble resin used in the invention is, in terms of a weight average molecular weight (Mw), preferably 30,000 or more, more preferably from 30,000 to 150,000, still more preferably from 30,000 to 100,000, and particularly preferably from 30,000 to 80,000.

When the water-insoluble resin has a molecular weight which is 30,000 or more, steric repulsion effect that the water-insoluble resin can exerts as a dispersant may improve and due to steric effect, the water-insoluble resin tends to easily adsorb to the pigment.

The number-average molecular weight (Mn) of the water-insoluble resin used in the present invention is preferably in the range of about 1,000 to about 100,000, more preferably in the range of about 3,000 to about 50,000. When the number-average molecular weight is in the range defined above, the water-insoluble resin may function as a coating film on the pigment or function as a coating film of the ink. The water-insoluble resin employed in the present invention is used preferably in the form of an alkali metal salt or an organic amine salt.

The molecular weight distribution (weight average molecular weight/number average molecular weight) of the water-insoluble resin used in the present invention is preferably from 1 to 6, and more preferably from 1 to 4. It is preferable that the molecular weight distribution is set within the above ranges in consideration of the dispersion stability and ejection stability of the ink composition.

The values of the number average molecular weight and the weight average molecular weight are values determined by measurement using a GPC analyzer with columns of TSKgel GMHxL, TSKgel G4000HxL and TSKgel G2000HxL (trade names, manufactured by Tosoh Corporation), THF as a solvent, and a differential refractometer as a detector, and conversion using polystyrene as a standard substance.

The water-insoluble resin used in the present invention can be synthesized using various polymerization methods, such as a solution polymerization, a precipitation polymerization, a suspension polymerization, a bulk polymerization, or an emulsion polymerization. The polymerization reaction can be performed by known operations such as a batch system, a semi-continuous system or a continuous system.

Examples of the method of polymerization initiation include a method using a radical initiator and a method using exposure to light or radiation. These polymerization methods and the polymerization initiation methods are described, for example, in Teiji Tsuruta, “Kobunshi Gousei Houhou” (Polymer Synthesis Method), revised edition (Nikkan Kogyo Shimbun (1971)) and Takayuki Otsu and Masayoshi Kinoshita, “Koubunshi Gousei-no Jikken-ho” (Experimental Method of Polymer Synthesis), (Kagaku-Dojin (1972)), pp. 124-154.

Specifically, the water-insoluble resin may be produced by subjecting a mixture which contains monomers and may further contain an organic solvent and a radical polymerization initiator in accordance with necessity to copolymerization under inert gas atmosphere. Among the polymerization methods, the solution polymerization method using a radical initiator is particularly preferable. Examples of the solvent used in the solution polymerization method include ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. These organic solvents may be used singly, or may be used in the form of a mixture of two or more kinds thereof, or may be mixed with water and used as a mixed solvent.

The polymerization temperature should be set in consideration of, for example, the molecular weight of the polymer to be formed and the kind of the initiator. In general, the polymerization temperature is from about 0° C. to about 100° C. It is preferable to perform polymerization at a temperature of from 50° C. to 100° C.

The reaction pressure can be suitably selected, and is usually from about 1 kg/cm² to about 100 kg/cm², and is preferably from about 1 kg/cm² to about 30 kg/cm². The reaction time may be from about 5 hours to about 30 hours. The obtained resin may be purified by reprecipitation or the like.

Preferable examples of the water-insoluble resin used in the present invention are shown below, while the invention is not limited thereto. Herein, a, b, c, d, e, f, g, h, and i each represent a ratio of the respective unit in terms of % by mass with respect to the total amount of the exemplified water-insoluble resin.

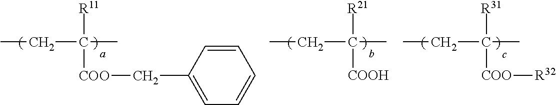

| | R¹¹ | R²¹ | R³¹ | R³² | a | b | c | Mw |
|---|---|---|---|---|---|---|---|---|
| B-1 | CH₃ | CH₃ | CH₃ | —CH₃ | 60 | 10 | 30 | 46000 |
| B-2 | H | H | H | —CH₃ | 60 | 10 | 30 | 50000 |
| B-3 | CH₃ | CH₃ | CH₃ | —CH₂CH₃ | 61 | 10 | 29 | 43000 |
| B-4 | CH₃ | CH₃ | CH₃ | —CH₂CH₂CH₂CH₃ | 61 | 9 | 30 | 51000 |
| B-5 | CH₃ | CH₃ | CH₃ | —CH(CH₃)₂ | 60 | 9 | 31 | 96000 |
| B-6 | H | H | H | —C(CH₃)₃ | 60 | 10 | 30 | 32000 |
| B-7 | CH₃ | CH₃ | CH₃ | —CH₂CH(CH₃)₂ | 70 | 5 | 25 | 75000 |

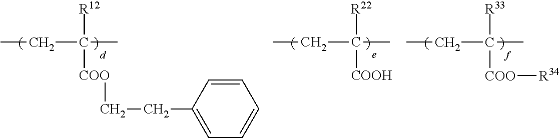

| | R¹² | R²² | R³³ | R³⁴ | d | e | f | Mw |
|---|---|---|---|---|---|---|---|---|
| B-8 | CH₃ | CH₃ | CH₃ | —CH₃ | 55 | 12 | 33 | 31000 |
| B-9 | H | H | H | —CH₂CH(CH₃)₂ | 70 | 10 | 20 | 34600 |

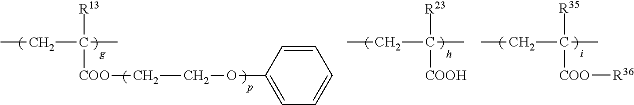

| | R¹³ | p | R²³ | R³⁵ | R³⁶ | g | h | i | Mw |
|---|---|---|---|---|---|---|---|---|---|
| B-10 | CH₃ | 1 | CH₃ | CH₃ | —CH₃ | 60 | 9 | 31 | 35500 |
| B-11 | H | 1 | H | H | —CH₂CH₃ | 69 | 10 | 21 | 41200 |
| B-12 | CH₃ | 2 | CH₃ | CH₃ | —CH₃ | 70 | 11 | 19 | 68000 |
| B-13 | CH₃ | 4 | CH₃ | CH₃ | —CH(CH₃)₂ | 70 | 7 | 23 | 72000 |
| B-14 | H | 5 | H | H | —CH₃ | 70 | 10 | 20 | 86000 |
| B-15 | H | 5 | H | H | —CH₂CH(CH₃)₂ | 70 | 2 | 28 | 42000 |

B-16

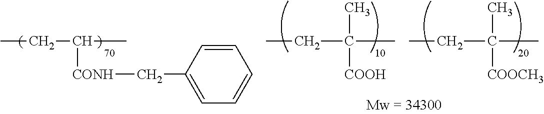

| | | Mw |
|---|---|---|
| B-17 | 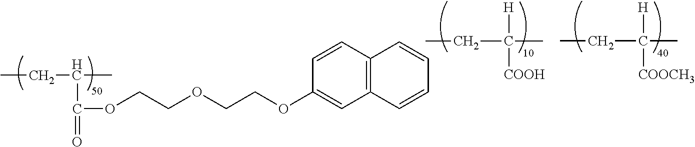 | 72400 |
| B-18 | 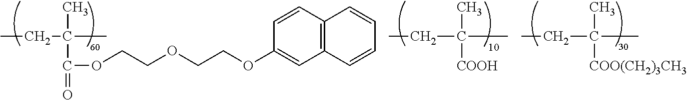 | 33800 |
| B-19 | 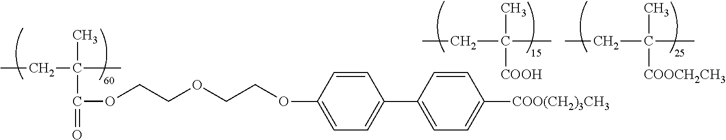 | 39200 |
| B-20 | 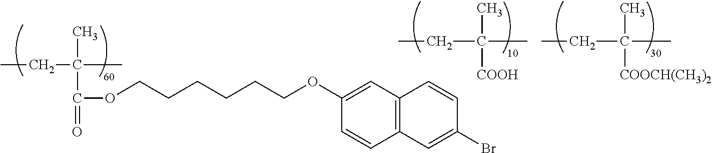 | 55300 |

Self-Dispersible Pigment

In the present invention, (2) a self-dispersible pigment is also recited as a preferable example. The self-dispersing pigment refers to a pigment to the surface of which a lot of hydrophilic functional groups and/or salts thereof (hereinafter, referred to as dispersibility-imparting groups) are bonded directly or through an alkyl group, an alkyl ether group, an aryl group, or the like, whereby the pigment is dispersible in an aqueous medium without a dispersant. Herein, the term “dispersible in an aqueous medium without a dispersant” refers to the state in which a pigment is dispersible in an aqueous medium without a dispersant for dispersing the pigment.

The ink containing a self-dispersible pigment as a colorant (coloring agent) is not necessary to contain the above-described dispersant that is contained to disperse an ordinary pigment. As a result, there are almost no chances that foam formation is induced by reduction in defoaming properties arising from a dispersant. Therefore, an ink having excellent ejection properties is easy to be prepared.

Examples of the dispersibility-imparting groups that are bonded to the surface of the self-dispersible pigment include —COOH, —CO, —OH, —SO₃H, —PO₃H₂, quaternary ammonium, and salts thereof. These groups can be produced by subjecting the pigment as a raw material to a physical processing or a chemical processing so that a dispersibility-imparting group or active species having a dispersibility-imparting group can be bonded (grafted) to the surface of the pigment. Examples of the physical processing include a vacuum plasma processing. Examples of the chemical processing include a wet oxidation process in which a surface of a pigment is oxidized with an oxidant in water, and a process of bonding a carboxyl group through a phenyl group by bonding p-aminobenzoic acid to a surface of a pigment.

In the present invention, preferable examples of the self-dispersible pigments include those that are surface-treated by oxidation treatment using hypohalous acid and/or a salt of hypohalous acid, or by ozone oxidation treatment. The self-dispersible pigments are also available from commercialized products. Examples of the commercialized products include MICROJET CW-1 (trade name, produced by Orient Chemical Industries Co., Ltd.), CAB-O-JET 200, and CAB-O-JET 300 (each trade name, produced by Cabot Corporation).

The pigment used in the present invention may be used singly or in a combination of two or more kinds of pigments selected from each within-group or between groups described above.

Resin Dispersible Pigment

In addition to the above-described encapsulation method, as an example of a method of manufacturing the “pigment particles covered with water-insoluble resin” in the invention, a pigment dispersion can be manufactured by dispersing the pigment particles using a water-insoluble resin as a dispersant.

In such a way, pigment particles with a microparticulated size can be formed, and high dispersion stability after dispersion can be attained. In this case, the entire surface of the pigment particles is not necessarily covered with the water-insoluble resin, but at least a part of the pigment particles may be covered with the water-insoluble resin, as occasion demands.

The pigment dispersion can be manufactured, for example, using the phase-inversion emulsification method as described in the above. More specifically, after preparation of a fluid dispersion by mixing and dispersing the pigment, the above-described water-insoluble resin (as a dispersant), water, and a water-insoluble volatile solvent, the water-insoluble volatile solvent is removed from the resultant dispersion. At this time, a part or all of the anionic groups of the water-insoluble resin may be neutralized by adding a basic compound. An excellent dispersibility can be attained by controlling the neutralization. Examples of the basic compound include sodium hydroxide.

Further, at this time, an alkylene oxide adduct of glycerol, which will be described later, may be added together with the water-insoluble volatile solvent.

The dispersion can be performed using known methods of agitating and dispersing after mixing desired components, or using known agitating and dispersing machines. The dispersion can be performed, for example, by using a ball mill, a roll mill, a bead mill, a high-pressure homogenizer, a high-speed agitating dispersion machine and a ultrasonic homogenizer.

Dispersant for Pigment

At the time of manufacturing the pigment dispersion, the water-insoluble resin can be used as a dispersant. At this time, the other dispersant for pigment in addition to the water-insoluble resin may be used together.

The other dispersant for the pigment can be appropriately selected from the compounds having a function for dispersing pigment in an aqueous phase. Examples of dispersants for pigment include a nonionic compound, an anionic compound, a cationic compound and amphoteric compound.

For example, as dispersants, homopolymers or copolymers of monomers having an a, β-ethylenically unsaturated group and the like are exemplified. Examples of the monomers having an α,β-ethylenically unsaturated group include ethylene, propylene, butene, pentene, hexene, vinyl acetate, allyl acetate, acrylic acid, methacrylic acid, crotonic acid, crotonic acid ester, itaconic acid, itaconic acid monoester, maleic acid, maleic acid monoester, maleic acid diester, fumaric acid, fumaric acid monoester, vinyl sulfonic acid, styrene sulfonic acid, sulfonated vinyl naphthalene, vinyl alcohol, acrylamide, methacryloxy ethyl phosphate, bismethacryloxyethyl phosphate, methacryloxyethylphenyl acid phosphate, ethyleneglycol dimethacrylate, diethyleneglycol dimethacrylate, styrene, styrene derivatives such as α-methyl styrene, vinyltoluene; vinyl cyclohexane, vinyl naphthalene, vinyl naphthalene derivatives, an alkyl acrylate which may have an aromatic substituent, a phenyl acrylate, an alkyl methacrylate which may have an aromatic substituent, a phenyl methacrylate, a cycloalkyl methacrylate, an alkyl crotonate, a dialkyl itaconate, a dialkyl maleate, vinyl alcohol, and derivatives of the above compounds.

Homopolymers or copolymers of monomers having the α,β-ethylenically unsaturated group may be used as a polymer dispersant.

Examples of the polymer dispersants include an alkyl acrylate-acrylic acid copolymer, an alkyl methacrylate-methacrylic acid copolymer, a styrene-alkyl acrylate-acrylic acid copolymer, styrene-phenylmethacrylate-methacrylic acid copolymer, styrene-cyclohexyl methacrylate-methacrylic acid copolymer, styrene-styrene sulfonic acid copolymer, styrene-maleic acid copolymer, styrene-methacrylic acid copolymer, styrene-acrylic acid copolymer, vinyl naphthalene-maleic acid copolymer, vinyl naphthalene-methacrylic acid copolymer, vinyl naphthalene-acrylic acid copolymer, polystyrene, polyester and polyvinyl alcohol.

Water-Insoluble Volatile Solvent

When the pigment dispersion is prepared, at least one water-insoluble volatile solvent may be used. Since the water-insoluble volatile solvent has less influence on the dispersibility, the water-insoluble volatile solvent can be removed finally, while maintaining a good dispersibility in the dispersion process, so that the dispersion can be thickened while maintaining a good dispersion state, and the pigment dispersion with an excellent storability over a long period of time can be obtained. Moreover, when an ink composition is prepared and used for recording, an image recording with a high ink ejection stability and suppressed curl of a recording medium can be attained.

The term “water-insolubility” refers to the characteristic such that when a solvent is mixed with pure water in the same amount of the solvent, and the mixture is gently stirred at one atmospheric pressure and 20° C., the mixture does not appear to be homogeneous, even after the flow due to stirring is ceased. The solubility with respect to water at 20° C. is preferably 80 g/100 ml or less, and more preferably 50 g/100 ml or less.

The “volatility” of a solvent means that the solvent has a boiling point of 200° C. or less, and preferably 150° C. or less.

The water-insoluble volatile solvent may be appropriately selected from organic solvents with water-insolubility and volatility. Specific examples of the water-insoluble volatile solvents include ketone-based solvents (for example, methyl ethyl ketone, diethyl ketone and the like), and ether-based solvents (for example, dibutyl ether and the like). In particular, from the viewpoint of the dispersion stability, ketone-based solvents are preferable, and methyl ethyl ketone is particularly preferable.

The use amount of the water-insoluble volatile solvent is preferably from 10% by mass to 1,000% by mass, more preferably from 50% by mass to 800% by mass, and still more preferably from 100% by mass to 500% by mass with respect to the use amount of the alkyleneoxide adduct of glycerol, in view of good dispersibility and stability after dispersion, and the ink ejection stability when the water-insoluble volatile solvent is used for an ink composition for recording, and suppression of curl of a recorded medium.

The water-insoluble volatile solvent as described in the above is preferably removed from the liquid after the pigment is dispersed. In such a way, the amount of the water-insoluble volatile solvent which becomes unnecessary finally is reduced, and thickened pigment dispersion can be obtained, while the dispersibility of pigment and storability of the dispersion can be maintained over a long period of time. Further, when the water-insoluble volatile solvent is used for preparation of pigment ink, and the ink is used for recording an image, the ink ejection stability can be attained, and occurrence of curl of a recording medium can be prevented.

The removal of the water-insoluble volatile solvent can be performed by conventional methods including a drying method such as heating or air blowing, or distillation under reduced pressure, and the water-insoluble volatile solvent is distilled away from the dispersion obtained by the dispersion process, so that the dispersion is thickened and phase-inverted to an aqueous system. In this case, when the water-insoluble resin is used as a dispersant for pigment, a dispersion of pigment particles, in which the surface of the pigment particles is covered with the water-insoluble resin, can be obtained.

It is preferable that, after the removal process of the water-insoluble volatile solvent, the water-insoluble volatile solvent is substantially removed from the prepared pigment dispersion. Specifically, the remaining amount of the water-insoluble volatile solvent in the pigment dispersion is preferably 5% by mass or less with respect to the addition amount of the water-insoluble volatile solvent at the time of dispersing, from the viewpoint of the thickening of the pigment dispersion, the ejection stability when an ink composition using the water-insoluble volatile solvent is used, and the suppression of occurrence of curl of a recording medium. The remaining amount of the water-insoluble volatile solvent in the pigment dispersion is preferably 1% by mass or less, and more preferably 0.1% by mass or less.

The average particle diameter of pigment particles dispersed in the pigment dispersion is preferably in the range of from 30 nm to 200 nm, and more preferably in the range of from 50 nm to 150 nm. When the average particle diameter of pigment particles is 30 nm or more, the production suitability is improved, and when the average particle diameter of pigment particles is 200 nm or less, the storability of the dispersion becomes good. The size distribution of the pigment particles covered with resin is not specifically restricted, and either particles having a broad particle diameter distribution or particles having a mono-dispersed particle diameter distribution may be used.

Further, the average particle diameter and of the particle size distribution of pigment particles can be obtained by measuring the volume average particle diameter by a dynamic light scattering method using NANOTRAC particle size distribution measuring device UPA-EX150 (trade name, manufactured by Nikkiso Co., Ltd.).

Although the content of the “pigment covered with water-insoluble resin” in the ink composition of the present invention is not specifically restricted, the content is preferably from 0.05% by mass to 30% by mass, more preferably from 0.1% by mass to 20% by mass, and particularly preferably from 0.15% by mass to 15% by mass. When the content is 0.05% by mass or more, the phenomena that ink coloration (coloring properties) becomes insufficient can be effectively prevented. Further, when the content is 30% by mass or less, an increase in the viscosity of ink can be effectively suppressed and deterioration of the ink ejection stability and the like can be effectively prevented.

Polymer Particles

The ink composition used in the present invention contains at least one kind of polymer particles having a glass transition temperature (Tg) of 50° C. or higher.

The polymer particles are used preferably as a resin fine particle dispersion (latex) in which the particles are dispersed in water.

The polymer particles are not particularly limited. Examples of polymer particles include polymer particles composed of a resin, such as a thermoplastic resin, for example, an acrylic resin, an epoxy resin, a polyurethane resin, a polyether resin, polyamide resin, an unsaturated polyester resin, a phenol resin, a silicone resin, or a fluorine resin; polyvinyl-based resins, for example, a vinyl chloride-based resin, a vinyl acetate-based resin, polyvinyl alcohol, or polyvinyl butyral; polyester resins, for example, an alkyd resin, or a phthalic acid resin; or a copolymer or a mixture of these resins.

The polymer particles preferably have a function that increases viscosity of an ink as a result of aggregation or destabilization of the dispersion coursed by the contact of the polymer particles with a reaction liquid capable of forming aggregates by the contact with the ink composition described below, or with a region of a paper on which the reaction liquid is dried, whereby the ink composition, namely image is solidified. These polymer particles are preferably those dispersed in at least one of water or organic solvents.

From the viewpoint of the stability of an ink composition, the weight average molecular weight of the polymer particles used in the present invention is preferably from 10,000 to 200,000, and more preferably from 100,000 to 200,000.

The polymer particles used in the present invention are preferably polymer latex, and the average particle diameter of the polymer particles is preferably from 10 nm to 1 μm, more preferably from 10 nm to 200 nm, further more preferably from 20 nm to 100 nm and particularly preferably from 20 nm to 50 nm.

The size distribution of the polymer particle latex is not specifically restricted, and either particles having a broad particle diameter distribution or particles having a mono-dispersed particle diameter distribution may be used. Further, two or more kinds of latexes each having mono-disperse particle distribution may be used.

The glass transition temperature (Tg) of the polymer particles used in the present invention is 50° C. or more, preferably 60° C. or more, and further more preferably 80° C. or more. Incorporation of the polymer particles having a Tg of 50° C. or more makes it possible to effectively increase fixing property of the ink composition on a recording medium and rubbing resistance. The Tg of the polymer particles is more preferably from 50° C. to 220° C., further more preferably from 60° C. to 200° C., and still further preferably from 80° C. to 200° C.

Tg of the polymer particles can be properly controlled by an ordinarily used method. For example, Tg of the polymer particles can be properly controlled in a desired range by properly selecting the kind of a polymerizable group of a polymer-constituting monomer, the kind of a substituent on the monomer, its component ratio, a molecular weight of a polymer molecule constituting the polymer particle, or the like.

Tg applies a measured Tg that is obtained by an actual measurement. Specifically, the measured Tg refers to a value measured under the ordinary conditions of measurement using a differential scanning calorimeter (DSC) EXSTAR 6220 (trade name, manufactured by SII NanoTechnology Inc.). However, in the case of difficulty of measuring Tg due to decomposition of resins or the like, Tg applies a calculated Tg that is calculated using the following calculating formula. Namely, the calculated Tg is calculated according to the following formula (1).

1/Tg=Σ(Xᵢ/Tgᵢ) (1)

Herein, the polymer as an object of calculation is assumed that n kinds (i is from 1 to n) of monomer components are copolymerized. Xᵢ is a weight fraction of the i^{th} monomer (Σ. Xᵢ=1). Tgᵢ is a glass transition temperature (absolute temperature) of a homopolymer derived from the i^{th} monomer. Σ represents the sum of values obtained respectively when i is from 1 to n. The value of glass transition temperature (Tgᵢ) of a homopolymer derived from each monomer applies the value described in Polymer Handbook (3^{rd} Edition) authored by J. Brundrup and E. H. Immergut (Wiley-Interscience, 1989).

In the ink composition used in the present invention, from the viewpoints of enhancing rubbing resistance, blocking resistance, and offset resistance, the content of polymer particles (resin solid content by mass) is preferably more than the content of pigment (pigment solid content by mass). The solid content ratio by mass (a)/(b) of polymer particles (a) to pigment (b) is preferably from 1 to 10, and more preferably from 1.2 to 5.

Further, from the viewpoint of the properties (such as glossiness and rubbing resistance) of the image after fixation, the mass ratio of the content of the pigment to the sum of the content of the water-insoluble resin and the content of the polymer particles (content of pigment/content of (water-insoluble resin+polymer particles)) is preferably 1.0 or less, more preferably 0.9 or less, and most preferably 0.8 or less.

Self-Dispersible Polymer Particles

The polymer particles used in the present invention is preferably a self-dispersible polymer particles, and more preferably a self-dispersible polymer particles having a carboxyl group, from the viewpoints of ejection stability, liquid stability (particularly dispersion stability) when the pigment described above is used, and further in consideration of imparting high-speed-ink-droplet-ejecting printability.

The “self-dispersible polymer particles” refer to fine particles of a water-insoluble polymer (hereinafter, may be referred to as “a first polymer”) that can be in a dispersion state in an aqueous medium in the absence of another surfactant by a functional group (particularly an acidic group or a salt thereof) contained in the polymer and that does not contain a free emulsifier.

The “dispersion state” can be either an emulsion state, in which the water-insoluble polymer is dispersed as a liquid in an aqueous medium, or a suspension state, in which the water-insoluble polymer is dispersed as a solid in an aqueous medium.

From the viewpoint of the aggregation rate and the fixing property when the water-insoluble polymer is employed to form the ink composition, the water-insoluble polymer used in the invention is preferably one that can be in the suspension state, in which the water-insoluble polymer is dispersed as a solid in an aqueous medium.

The “dispersion state” of the self-dispersible polymer particles used in the invention refers to a state in which a self-dispersible polymer particles can be visually confirmed as being in a stable dispersion state at 25° C. over at least one week, even after the self-dispersible polymer particle dispersion has been prepared by mixing and stirring, by using a stirrer having a stirring blade with number of rotations of 200 rpm for 30 minutes at 25° C., a mixture solution of a solution containing 30 g of the water-insoluble polymer dissolved in 70 g of organic solvent such as methyl ethyl ketone, a neutralizer which can neutralize all salt-forming groups of the water-insoluble polymer, and 200 g of water, and then removing the organic solvent from the mixture solution, wherein the neutralizer is either sodium hydroxide when the salt-forming group is anionic, or acetic acid when the salt-forming group is cationic.

The “water-insoluble polymer” refers to a polymer whose dissolved amount to 100 g of water at 25° C. is 10 g or lower when the polymer is dried at 105° C. for 2 hours and then dissolved in the water. The dissolved amount is preferably 5 g or lower, and more preferably 1 g or lower. The “dissolved amount” is an amount of (a part of) the water-insoluble polymer dissolved in a solvent (water) when the water-insoluble polymer is completely neutralized with sodium hydroxide or acetic acid, wherein the selection from the sodium hydroxide and the acetic acid accords to the type of the salt-forming group of the water-insoluble polymer.

The aqueous medium contains water and may further contain a hydrophilic organic solvent as required. In preferable embodiments, the aqueous medium contains water and a hydrophilic organic solvent, an amount of the hydrophilic organic solvent being in a range of 0.2% by mass or less with respect to water, and in more preferable embodiments, the aqueous medium is substantially water.

There is no limitation on the main chain skeleton of the water-insoluble polymer. Examples of the polymer include a vinyl polymer and a condensed polymer (e.g., an epoxy resin, polyester, polyurethane, polyamide, cellulose, polyether, polyurea, polyimide, and polycarbonate). Among the above, a vinyl polymer is particularly preferable.

Preferable examples of a vinyl polymer and a monomer which configures the vinyl polymer include substances disclosed in JP-A Nos. 2001-181549 and 2002-88294. Moreover, a vinyl polymer in which a dissociating group has been introduced into a terminal of a polymer chain by radical polymerization of a vinyl monomer using either chain transfer agent or polymerization initiator having a dissociating group (or a substituent that can be converted to a dissociating group) or an iniferter or by ion polymerization using a compound having a dissociating group (or a substituent that can be converted to a dissociating group) in either an initiator or a stopper also can be used.

Preferable examples of a condensed polymer and a monomer which configures the condensed polymer include substances described in JP-A No. 2001-247787.

The self-dispersing polymer particles used in the present invention preferably includes a water-insoluble polymer containing a hydrophilic structural unit and a structural unit derived from an aromatic group-containing monomer as a hydrophobic structural unit from the viewpoint of self-dispersibility.

There is no limitation on the hydrophilic structural unit insofar as it is derived from a hydrophilic group-containing monomer, and may be derived from one hydrophilic group-containing monomer or may be derived from two or more hydrophilic group-containing monomers. The hydrophilic group is not limited and may be a dissociating group or a nonionic hydrophilic group.

The hydrophilic group is preferably a dissociating group, and more preferably an anionic dissociating group, from the viewpoints of promoting the self-dispersibility and improving stability of the emulsion state or dispersion state of the self-dispersible polymer particles. Examples of the dissociating group include a carboxyl group, a phosphoric acid group, and a sulfonic acid group. Among the above, the carboxyl group is preferable from the viewpoint of fixing property when the ink composition is formed therewith.

The hydrophilic group-containing monomer used in the present invention is preferably a dissociating group-containing monomer from the viewpoints of self-dispersibility and aggregation properties, and specifically, the hydrophilic group-containing monomer is preferably a dissociating group-containing monomer having a dissociating group and an ethylenically unsaturated bond.

Examples of the dissociating group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methylsuccinic acid. Specific examples of the unsaturated sulfonic acid monomer include styrene sulfonic acid, 2-acrylamido-2-methyl propane sulfonic acid, 3-sulfopropyl (meth)acrylate, and bis-(3-sulfopropyl)-itaconate. Specific examples of the unsaturated phosphoric acid monomer include vinyl phosphoric acid, vinyl phosphate, bis(methacryloxyethyl)phosphate, diphenyl-2-acryloyloxyethyl phosphate, diphenyl-2-methacryloyloxyethyl phosphate, and dibutyl-2-acryloyloxyethyl phosphate.

Among the dissociating group-containing monomers, from the viewpoint of dispersion stability and ejection stability, the unsaturated carboxylic acid monomer is preferable, and acrylic acid and methacrylic acid are more preferable.

In preferable embodiments, the self-dispersible polymer particles employed in the invention contain a first polymer having a carboxyl group and an acid value (mgKOH/g) of 25 to 100 from the viewpoints of improving self-dispersibility and an aggregation rate when the ink composition contacts a reaction liquid. In more preferable embodiments, the acid value is from 25 to 80, and in particularly preferable embodiments, the acid value is from 30 to 65, from the viewpoints of improving self-dispersibility and an aggregation rate when the ink composition contacts a reaction liquid.

Stability of the dispersion state of the self-dispersible polymer particles can be favorable when the acid value is 25 or more, and the aggregation properties can be improved when the acid value is 100 or lower. Further, the acid value of the self-dispersible polymer particles is preferably less than that of the above-described water-insoluble polymer (a second polymer) from the viewpoints of improving dispersion stability of a pigment in combination with an aggregation rate when the ink composition contacts a reaction liquid. A difference in the acid value between a second polymer and a first polymer is preferably from 5 to 70, and more preferably from 10 to 70.

There is no limitation on the aromatic group-containing monomer insofar as it is a compound containing an aromatic group and a polymerizable group. The aromatic group may be a group derived from an aromatic hydrocarbon or a group derived from an aromatic heterocyclic ring. In the present invention, the aromatic group is preferably an aromatic group derived from an aromatic hydrocarbon from the viewpoint of particle shape stability in an aqueous medium.

The polymerizable group may be a condensation polymerizable group or an addition polymerizable group. In the present invention, from the viewpoint of particle shape stability of the self-dispersible polymer particles in the aqueous medium, the polymerizable group preferably an addition polymerizable group, and more preferably a group containing an ethylenically unsaturated bond.

The aromatic group-containing monomer used in the present invention is preferably a monomer having an ethylenically unsaturated bond and an aromatic group derived from aromatic hydrocarbon, and more preferably an aromatic group-containing (meth)acrylate monomer. The aromatic group-containing monomers may be used singly or in combination of two or more.

Examples of the aromatic group-containing monomer include phenoxyethyl(meth)acrylate, benzyl(meth)acrylate, phenyl(meth)acrylate, and a styrene monomer. From the viewpoints of well-balancing hydrophilicity and hydrophobicity of the polymer chain of the self-dispersible polymer particles and ink fixing property, the aromatic group-containing monomer is preferably at least one selected from the group consisting of phenoxyethyl(meth)acrylate, benzyl(meth)acrylate, and phenyl(meth)acrylate, more preferably phenoxyethyl(meth)acrylate, and phenoxyethylacrylate is especially preferable.

The “(meth)acrylate” refers to acrylate or methacrylate.

Of these aromatic group-containing monomers, at least one of dicyclic (meth)acrylates or tricyclic or more polycyclic (meth)acrylates is preferable from the viewpoints of dispersion stability of self-dispersible polymer particles, fixing properties, and blocking resistance. Further, at least one of isobornyl(meth)acrylate, adamantyl(meth)acrylate, or dicyclopentanyl(meth)acrylate is more preferable from the same reasons as described above.

The self-dispersible polymer particles used in the present invention is preferably a acrylic resin containing a structural unit derived from a (meth)acrylate monomer, more preferably a acrylic resin containing a structural unit derived from an aromatic group-containing (meth)acrylate, and further preferably a acrylic resin containing a structural unit derived from an aromatic group-containing (meth)acrylate, the content of which being from 10% by mass to 95% by mass. When the content of the aromatic group-containing (meth)acrylate is from 10% by mass to 95% by mass, self-emulsifying property or stability of the dispersion state is improved, and moreover an increase in ink viscosity can be suppressed.

In the present invention, the content of the aromatic group-containing (meth)acrylate is more preferably from 15% by mass to 90% by mass, further preferably from 15% by mass to 80% by mass, and particularly preferably from 25% by mass to 70% by mass, from the viewpoints of improvement in stability of self-dispersion state, stabilization of the particle shape in an aqueous medium due to hydrophobic interaction between aromatic rings or between alicyclic hydrocarbon groups, and reduction in the amount of water-soluble components due to appropriate hydrophobization of particles.

The self-dispersible polymer particles used in the invention can be formed by using, for example, a structural unit derived from an aromatic group-containing monomer and a structural unit derived from a dissociating group-containing monomer. The self-dispersible polymer particles may further contain other structural units as needed.

While there is no limitation on a monomer which forms the other structural unit insofar as it can be copolymerized with the aromatic group-containing monomer and the dissociating group-containing monomer, from the viewpoint of flexibility of the main chain skeleton of the water-insoluble polymer or ease of regulation of glass transition temperature (Tg), an alkyl group-containing monomer is preferable.

Examples of the alkyl group-containing monomer include (meth)acrylate monomers and (meth)acrylaide monomers. Examples of the (meth)acrylate monomers include alkyl(meth)acrylates, such as methyl(meth)acrylate, ethyl(meth)acrylate, isopropyl(meth)acrylate, n-propyl(meth)acrylate, n-butyl(meth)acrylate, isobutyl(meth)acrylate, t-butyl(meth)acrylate, hexyl(meth)acrylate, or ethylhexyl(meth)acrylate; ethylenically unsaturated monomers having a hydroxyl group, such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, or hydroxyhexyl(meth)acrylate; and dialkylamino alkyl(meth)acrylates, such as dimethylaminoethyl(meth)acrylate. Examples of the (meth)acrylamide monomers include N-hydroxyalkyl(meth)acrylamides, such as N-hydroxymethyl(meth)acrylamide, N-hydroxyethyl(meth)acrylamide, or N-hydroxybutyl(meth)acrylamide; and N-alkoxyalkyl(meth)acrylamides, such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, or N-(n-, iso)butoxyethyl(meth) acrylamide.

The molecular weight range of the water-insoluble polymer which configures the self-dispersible polymer particles used in the present invention is, in terms of weight average molecular weight, preferably from 3,000 to 200,000, more preferably from 5,000 to 150,000, and still more preferably from 10,000 to 100,000. By adjusting the weight average molecular weight to 3,000 or more, the content of water-soluble components can be effectively reduced. By adjusting the weight average molecular weight to 200,000 or less, stability of self-dispersibility can be increased.

The weight average molecular weight can be measured by gel permeation chromatography (GPC). GPC may be conducted using HLC-8020GPC (trade name, manufactured by Tosoh Corporation), three columns of TSK gel Super HZM-H, TSK gel Super HZ 4000 and TSK gel Super HZ 2000 (each trade names, manufactured by Tosoh Corporation, 4.6 mm ID×15 cm), and THF (tetrahydrofuran) as an eluate.

From the viewpoint of regulation of hydrophilicity and hydrophobicity of a polymer, the water-insoluble polymer which configures the self-dispersible polymer particles used in the invention preferably contains a structural unit derived from the aromatic group-containing (meth)acrylate (preferably a structural unit derived from phenoxyethyl(meth)acrylate and/or a structural unit derived from benzyl(meth)acrylate,), wherein the content (copolymerization ratio) of the structural unit derived from the aromatic group-containing (meth)acrylate is preferably from 15% by mass to 80% by mass with respect to the total amount of self-dispersible polymer particles.

From the viewpoint of regulation of hydrophilicity and hydrophobicity of a polymer, in preferable embodiments, the water-insoluble polymer preferably contains a structural unit derived from the aromatic group-containing (meth)acrylate monomer and a structural unit derived from a carboxyl group-containing monomer and a structural unit derived from an alkyl group-containing monomer (preferably a structural unit derived from alkyl ester of (meth)acrylic acid wherein the content (copolymerization ratio) of the structural unit derived from the aromatic group-containing (meth)acrylate monomer is preferably from 15% by mass to 80% by mass with respect to the total amount of self-dispersible polymer particles. In more preferable embodiments, the water-insoluble polymer contains a structural unit derived from phenoxyethyl(meth)acrylate and/or a structural unit derived from benzyl(meth)acrylate and a structural unit derived from a carboxyl group-containing monomer and a structural unit derived from an alkyl group-containing monomer (preferably a structural unit derived from alkyl ester of (meth)acrylic acid, the alkyl moiety having 1 to 4 carbon atoms), wherein the content (copolymerization ratio) of the structural unit derived from phenoxyethyl(meth)acrylate and/or the structural unit derived from benzyl(meth)acrylate is from 15% by mass to 80% by mass with respect to the total amount of self-dispersible polymer particles. In addition, the water-insoluble polymer preferably has the acid value of from 25 to 100 and the weight average molecular weight of 3,000 to 200,000, and more preferably has the acid value of from 25 to 95 and the weight average molecular weight of 5,000 to 150,000.

Hereinafter, exemplary compounds B-01 to B-19 and C-01 to C-05 are shown as specific examples of the water-insoluble polymer which configures the self-dispersible polymer particles, although the invention is not limited thereto. The ratio in brackets represents the mass ratio of copolymerization components.

B-01: Phenoxyethyl acrylate/Methyl methacrylate/Acrylic acid copolymer (50/45/5)
B-02: Phenoxyethyl acrylate/Benzyl methacrylate/Isobutyl methacrylate/Methacrylic acid copolymer (30/35/29/6)
B-03: Phenoxyethyl methacrylate/Isobutyl methacrylate/Methacrylic acid copolymer (50/44/6)
B-04: Phenoxyethyl acrylate/Methyl methacrylate/Ethylacrylate/Acrylic acid Copolymer (30/55/10/5)
B-05: Benzyl methacrylate/Isobutyl methacrylate/Methacrylic acid copolymer (35/59/6)
B-06: Styrene/Phenoxyethyl acrylate/Methyl methacrylate/Acrylic acid copolymer (10/50/35/5)
B-07: Benzyl acrylate/Methyl methacrylate/Acrylic acid copolymer (55/40/5)
B-08: Phenoxyethyl methacrylate/Benzyl acrylate/Methacrylic acid copolymer (45/47/8)
B-09: Styrene/Phenoxyethyl acrylate/Butyl methacrylate/Acrylic acid copolymer (5/48/40/7)
B-10: Benzyl methacrylate/Isobutyl methacrylate/Cyclohexyl methacrylate/Methacrylic acid copolymer (35/30/30/5)
B-11: Phenoxyethyl acrylate/Methyl methacrylate/Butyl acrylate/Methacrylic acid copolymer (12/50/30/8)
B-12: Benzyl acrylate/Isobutyl methacrylate/Acrylic acid copolymer (93/2/5)
B-13: Styrene/Phenoxyethyl methacrylate/Butyl acrylate/Acrylic acid copolymer (50/5/20/25)
B-14: Styrene/Butyl acrylate/Acrylic acid copolymer (62/35/3)
B-15: Methyl methacrylate/Phenoxyethyl acrylate/Acrylic acid copolymer (45/51/4)
B-16: Methyl methacrylate/Phenoxyethyl acrylate/Acrylic acid copolymer (45/49/6)
B-17: Methylmethacrylate/Phenoxyethyl acrylate/Acrylic acid copolymer (45/48/7)
B-18: Methyl methacrylate/Phenoxyethyl acrylate/Acrylic acid copolymer (45/47/8)
B-19: Methylmethacrylate/Phenoxyethyl acrylate/Acrylic acid Copolymer (45/45/10)
C-01: Methyl methacrylate/Isobornyl methacrylate/Methacrylic acid copolymer (20/72/8)
C-02: Methyl methacrylate/Isobornyl methacrylate/Methacrylic acid copolymer (40/52/8)
C-03: Methyl methacrylate/Isobornyl methacrylate/Methacrylic acid copolymer (10/88/2)
C-04: Methyl methacrylate/Isobornyl methacrylate/Dicyclopentanyl methacrylate/Methacrylic acid copolymer (20/62/10/8)

C-05: Methyl methacrylate/Dicyclopentanyl methacrylate/Methacrylic acid copolymer (20/72/8)

There is no particular limitation on a method of producing the water-insoluble polymer which configures the self-dispersible polymer particles used in the present invention. Examples of the method include a method of performing emulsion polymerization in the presence of a polymerizable surfactant to covalently bind a surfactant and a water-insoluble polymer; and a method of copolymerizing a monomer mixture containing the above-described hydrophilic group-containing monomer and the above-described aromatic group-containing monomer by known polymerization methods such as a solution-polymerization method or a block-polymerization method. Among these polymerization methods, the solution-polymerization method is preferable, and the solution-polymerization method using an organic solvent is more preferable, from the viewpoint of an aggregation rate and droplet ejecting stability when the self-dispersible polymer particles are employed in the ink composition.

From the viewpoint of an aggregation rate, it is preferable that the self-dispersible polymer particles used in the present invention contain a first polymer, the polymer being synthesized in an organic solvent and having a carboxyl group and the acid value of 25 to 100, and the self-dispersible polymer particles being prepared as a polymer dispersion in which at least a part of the carboxyl group of the first polymer is neutralized and water functions as a continuous phase.

More specifically, the method of producing the self-dispersible polymer particles used in the present invention preferably includes a process of synthesizing the first polymer in an organic solvent and a process of dispersing the first polymer to form an aqueous dispersion thereof, at least a part of the carboxyl group of the first polymer being neutralized.

The dispersing preferably includes the following processes (1) and (2).

Process (1): Stirring a mixture containing a first polymer (water-insoluble polymer), an organic solvent, a neutralizer, and an aqueous medium; and

Process (2): Removing the organic solvent from the mixture.

The process (1) preferably includes obtaining a dispersion by, at first, dissolving the first polymer (water-insoluble polymer) in an organic solvent, and then gradually adding a neutralizer and an aqueous medium, and mixing and stirring the mixture. The addition of the neutralizer and the aqueous medium to a solution of the water-insoluble polymer dissolved in an organic solvent makes it possible to obtain self-dispersible polymer particles having particle diameters capable of imparting higher storage stability without strong shearing force.

There is no limitation on a stirring method of the mixture, and generally-used mixing and stirring devices or, as required, dispersers such as an ultrasonic disperser or a high voltage homogenizer can be used.

Preferable examples of the organic solvent include an alcohol solvent, a ketone solvent, and an ether solvent.

Examples of the alcohol solvent include isopropyl alcohol, n-butanol, t-butanol, and ethanol. Examples of the ketone solvent include acetone, methyl ethyl ketone, diethyl ketone, and methyl isobutyl ketone. Examples of the ether solvent include dibutyl ether and dioxane. Among these solvents, the ketone solvent such as methyl ethyl ketone or the alcohol solvent such as isopropyl alcohol is preferable. It is also preferable to use isopropyl alcohol and methyl ethyl ketone in combination so that the change in polarity at the time of phase inversion from an oil phase to a water phase can be moderated. By using the solvents in combination, self-dispersible polymer particles that can be free from aggregation-precipitation or fusion of particles and can have high dispersion stability and fine particle diameters can be obtained.

The neutralizer is used for forming an emulsion state or a dispersion state in which the dissociating group is partially or thoroughly neutralized and the self-dispersible polymer is stabilized in water. Examples of the neutralizer which can be used when the self-dispersible polymer employed in the invention has an anionic dissociating group (e.g., a carboxyl group) as the dissociating group include basic compounds such as organic amine compounds, ammonia, or hydroxides of alkali metals. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and tri-isopropanolamine. Examples of the hydroxides of alkali metals include lithium hydroxide, sodium hydroxide, and potassium hydroxide. Among the above, from the viewpoint of stabilization of dispersion of the self-dispersible polymer particles employed in the invention in water, sodium hydroxide, potassium hydroxide, triethylamine, and triethanolamine are preferable.

The content of the basic compound is preferably from 5 to 120% by mol, more preferably from 10 to 110% by mol, and still more preferably from 15 to 100% by mol, with respect to 100% by mol of the dissociating groups. Stabilization of the dispersion of the particles in water can be further demonstrated when the content of the basic compound is adjusted to 15% by mol or more. Reduction in content of the water-soluble components can be effected when the content of the basic compound is adjusted to 100% by mol or less.

In the process (2), an aqueous dispersion of the self-dispersible polymer particles can be obtained by inverting a phase of the dispersion, which has been obtained in the process (1), to a water phase as a result of distilling off the organic solvent from the dispersion by a common procedure such as vacuum distillation. The thus-obtained aqueous dispersion is substantially free of the organic solvent. Specifically, the amount of the organic solvent contained in the aqueous dispersion is preferably 0.2% by mass or less, and more preferably 0.1% by mass or less.

The average particle diameter of the self-dispersible polymer particles is preferably in the range of 10 nm to 400 nm, more preferably in the range of 10 nm to 200 nm, and still more preferably in the range of 10 nm to 100 nm. When the average particle diameter is 10 nm or more, production suitability of the polymer particles may be increased. When the average particle diameter is 400 nm or less, the storage stability may be increased. The particle size distribution of the self-dispersible polymer particles is not particularly limited. The polymer particles may have either a broad particle size distribution or a monodisperse particle size distribution. Two or more water-insoluble particles may be used in combination as a mixture.

The average particle diameter and particle size distribution of the polymer particles can be determined by a light scattering method.

The self-dispersible polymer particles used in the present invention can be favorably contained in, for example, in a water-based ink composition and may be used solely or in combination of two or more kinds.

Urea or Urea Derivative

The ink composition used in the invention contains urea or a urea derivative. Urea and a urea derivative have a high wetting function, and have a function of inhibiting undesirable drying or coagulation of ink as a solid wetting agent, and urea or a urea derivative is preferably used in the ink composition.

Examples of the urea derivative that is used in the invention include a compound in which a hydrogen atom on a nitrogen atom in urea is substituted with an alkyl group or an alkanol, thiourea, and a compound in which a hydrogen atom on a nitrogen atom in thiourea is substituted with an alkyl group or an alkanol. Specific examples of the urea derivative include N,N-dimethylurea, thiourea, ethylene urea, hydroxyethyl urea, hydroxybutyl urea, ethylene thiourea, and diethyl thiourea.

The content of the urea or urea derivative in the ink composition used in the invention is preferably from 1.0% by mass to less than 20.0% by mass, more preferably from 2.0% by mass to less than 15.0% by mass, and further preferably from 3.0% by mass to less than 10.0% by mass, from the viewpoint of improving the wiping off property.

If two or more kinds of urea or urea derivatives are contained in the ink composition, the total content of the two or more kinds of urea or urea derivatives may be within the above-described range.

The combination of the content of the urea or urea derivative and the content of the polymer particles in the ink composition used in the invention is not particularly limited, but the following combinations are preferable from the viewpoint of more effectively balancing the wiping off property and the image fixability.

That is, the combination in which the content of the urea or urea derivative is 1.0% by mass or more and the content of the polymer particles is 5% by mass or more is preferable, the combination in which the content of the urea or urea derivative is from 1.0% by mass to 20% by mass and the content of the polymer particles is from 5% by mass to 20% by mass is more preferable, and the combination in which the content of the urea or urea derivative is from 3.0% by mass to 10% by mass and the content of the polymer particles is from 5% by mass to 10% by mass is particularly preferable.

The ratio of the content of the urea or urea derivative to the total solid content in the ink composition (sum of the contents of the water-insoluble resin, the pigment, and the polymer particles) (mass of the urea or urea derivative/mass of the total solid content) is preferably 0.3 or more, more preferably from 0.4 to 2.0, and most preferably from 0.5 to 1.5.

Solid Wetting Agent

The ink composition used in the invention may contain a solid wetting agent other than the urea or urea derivative.

In the invention, the solid wetting agent means a water-soluble compound that is water-retentive, and solid at 25° C.

As the solid wetting agent usable in the invention, those commonly used for aqueous ink compositions may be used, and specific examples include polyhydric alcohols such as sugars, sugar alcohols, hyaluronic acids, trimethylol propane, 1,2,6-hexanetriol, and the like.

Examples of the sugars include monosaccharide, disaccharide, oligosaccharides (including trisaccharides and tetraaccharides) and polysaccharides, specifically, glucose, mannose, fructose, ribose, xylose, arabinose, galactose, aldonic acid, glucitol, (sorbit), maltose, cellobiose, lactose, sucrose, trehalose, maltotriose are exemplified. Here, polysaccharides means sugars in a broad sense, and, are used for including substances such as alginic acid, α-cyclodextrin, or cellulose, which are widely distributed in nature. Further, derivatives of these sugars include reduced sugars of the above-described sugars (for example, sugar alcohol), and oxidized sugars (sugar acids) (for example, aldonic acid, uronic acid, amino acid, thiosugar, and the like). In particular, sugar alcohol is desirable, and specifically, maltitol, sorbitol, xylitol, and the like are exemplified. As hyaluronate, commercially available sodium hyaluronate (1% aqueous solution) (molecular weight 350,000) may be used.

Water-Soluble Organic Solvent

The ink composition used in the invention preferably contains a water-soluble organic solvent.

Examples of the water-soluble organic solvents include alkanediols or polyhydric alcohols such as glycerol, 1,2,6-hexanetriol, trimethylol propane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; alkyl alcohols having 1-4 carbon atoms, such as ethanol, methanol, butanol, propanol or isopropanol; glycol ethers such as ethyleneglycol monomethylether, ethyleneglycol monoethylether, ethyleneglycol monobutylether, ethyleneglycol monomethylether acetate, diethyleneglycol monomethylether, diethyleneglycol monoethylether, diethylene glycol mono-n-propylether, ethyleneglycol mono-iso-propylether, diethylene glycol mono-iso-propylether, ethyleneglycol mono-n-butylether, ethyleneglycol mono-t-butylether, diethyleneglycol mono-t-butylether, 1-methyl-1-methoxybutanol, propyleneglycol monomethylether, propyleneglycol monoethylether, propyleneglycol mono-t-butylether, propyleneglycol mono-n-propylether, propyleneglycol mono-iso-propylether, dipropyleneglycol monomethylether, dipropyleneglycol monoethylether, dipropyleneglycol mono-n-propylether or dipropyleneglycol mono-iso-propylether; 2-pyrrolidone, N-methyl-2-pyrrolidone, 1,3-dimethyl-2-imidazolizinone, formamide, acetamide, dimethylsulfoxide, sorbit, sorbitan, acetin, diacetin, triacetin or sulfolane. These compounds may be used singly, or may be used in combination of two or more kinds thereof.

For the purpose of imparting a dryness preventive property or a wetting property, it is useful to use polyhydric alcohols. Examples of polyhydric alcohols include glycerol, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol and 1,2,6-hexanetriol. These compounds may be used singly or may be used in combination of two or more kinds thereof. In view of penetrating property, it is desirable to use polyol compounds. Examples of polyol compounds include, for example, aliphatic diols such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol or 2-ethyl 1,3-hexanediol. In particular, 2-ethyl-1,3-hexanediol or 2,2,4-trimethyl-1,3-pentanediol is preferable. These compounds may be used singly or may be used in combination of two or more kinds thereof.

The content of the water-soluble organic solvent contained in the ink composition used in the invention is preferably from 1.0% by mass to 50% by mass, more preferably from 5.0% by mass to 40% by mass, and most preferably from 10% by mass to 30% by mass, from the viewpoint of imparting a dryness preventive property or a wetting property.

The water-soluble organic solvent contained in the ink composition of the invention preferably contains at least one water-soluble organic solvent having an SP value of 27.5 or less in an amount of 70% by mass or more, more preferably 80% by mass or more, from the viewpoint of suppressing curling of a recording medium caused when an image is recorded on the recording medium.

In general, when the content of a water-soluble organic solvent having an SP value of 27.5 or less is increased, in a combination with a pigment dispersion in which a known surfactant, water-soluble polymer dispersant or the like is used as the dispersant, since desorption of the dispersant adsorbed to the surface of the pigment is accelerated, the dispersion state becomes unstable, and the ink stability is lowered. In the invention, by using a pigment coated with a water-insoluble resin, the inhibition of curling of the recording medium and the ink stability may be simultaneously satisfied.

The SP value in the invention indicates a solubility parameter. Specifically, the SP value is a value represented by the square root of the molecular cohesive energy, and may be calculated by the method described in R. F. Fedors, Polymer Engineering Science, 14, p 147 (1967). Such a value is used in the invention.

Examples of a water-soluble organic solvent having an SP value of 27.5 or less are shown below.
Diethylene glycol monoethyl ether (22.4)
Diethylene glycol monobutyl ether (21.5)
Triethylene glycol monobutyl ether (21.1)
Dipropylene glycol monomethyl ether (21.3)
Dipropylene glycol (27.2)
nC₄H₉O(AO)₄—H (AO is EO or PO, and EO:PO ratio is 1:1) (20.1)
nC₄H₉O(AO)₁₀—H (AO is EO or PO, and EO:PO ratio is 1:1) (18.8)
HO(A′O)₄₀—H (A′O is EO or PO, and EO:PO ratio is 1:3) (18.7)
HO(A″O)₅₅—H (A″O is EO or PO, and EO:PO ratio is 5:6) (18.8)
HO(PO)₃—H (24.7)
HO(PO)₇—H (21.2)
1,2-hexanediol (27.4)

In the invention, EO and PO represent an ethyleneoxy group and a propyleneoxy group, respectively.

Further, the below-described alkylene oxide adducts of glycerol include compounds which are water-soluble organic solvents having an SP value of 27.5 or less. These compounds are also preferable, the detail of which is described below.

It is also preferable that the water-soluble organic solvent contained in the ink composition of the invention contains at least one alkylene oxide adduct of glycerol. When an alkylene oxide adduct of glycerol is contained, the dispersibility and the long term storage stability after dispersion are further improved, and the jetting stability of the ink composition is further improved.

The alkylene oxide adduct of glycerol is preferably a compound represented by the following Formula (1).

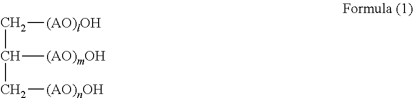

In Formula (1), l, m and n each independently represent an integer of 1 or more, and satisfy the relationship of 3≦l+m+n≦15. When the value of l+m+n is 3 or more, the curl suppression property is good, and when the value is 15 or less, the jetting property is good.

Further, the value of l+m+n is preferably from 3 to 12, and more preferable from 3 to 10.

AO in Formula (1) represents an ethyleneoxy group and/or a propyleneoxy group, and a propyleneoxy group is preferable. The AO in (AO)ₗ, (AO)ₘ and (AO)ₙ in Formula (1) may be the same or different from each other.

Hereinafter, specific examples of the compound represented by Formula (1) are shown, but in the invention, examples of the compound are not limited to them.

Each numerical value in parentheses represents an SP value.

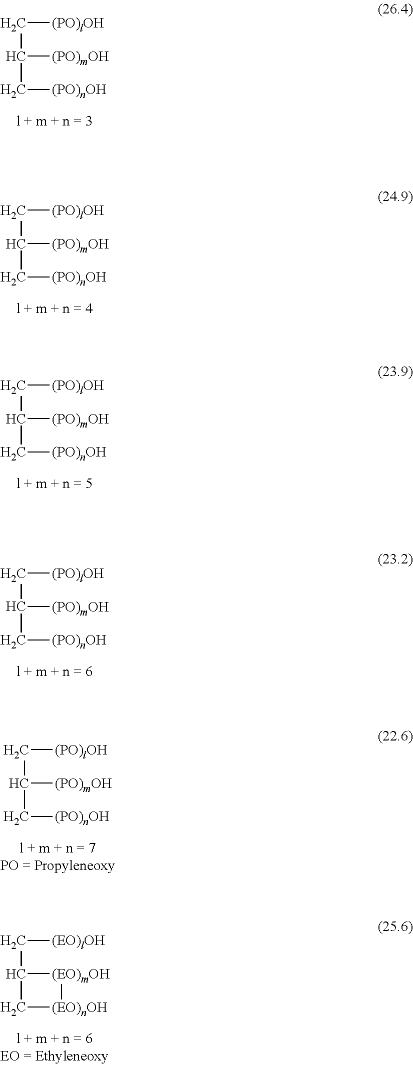

As the alkyleneoxide adduct of glycerol, commercially available products may be used. Examples of the commercially available product include, as examples of polyoxy propylated glycerol (ether of polypropylene glycol and glycerol), SANNIX GP-250 (average molecular weight of 250), SANNIX GP-400 (average molecular weight of 400), and SANNIX GP-600 (average molecular weight of 600) (each trade names, manufactured by Sanyo Chemical Industries, Ltd.), LEOCON GP-250 (average molecular weight of 250), LEOCON GP-300 (average molecular weight of 300), LEOCON GP-400 (average molecular weight of 400) and LEOCON GP-700 (average molecular weight of 700) (each trade names, manufactured by Lion Corporation); and polypropylene triol glycol•triol type products having average molecular weight of 300 and average molecular weight of 700 (each manufactured by Wako Pure Chemical Industries, Ltd.)

Water

Although the pigment dispersion used in the present invention contains water, the quantity of water is not particularly restricted. In particular, the content of water is preferably from 10% by mass to 99% by mass, more preferably from 30% by mass to 80% by mass, and still more preferably from 50% by mass to 70% by mass.

Other Components

The ink composition used in the present invention may contain other additives in addition to the above components. The other additives include, for example, known additives such as a surfactant, an ultraviolet absorber, an anti-fading agent, an antifungal agent, a pH adjuster, an antirust agent, an antioxidant, an emulsion stabilizer, an antiseptic agent, a defoaming agent, a viscosity adjustment agent, a dispersion stabilizer or a chelating agent.

The surfactant is used as a surface tension adjusting agent, and examples of the surfactant includes a nonionic surfactant, a cationic surfactant, an anionic surfactant and a betaine surfactant. In order to eject inkjet droplets suitably on a recording medium, the surface tension adjusting agent is added to an ink composition in such an amount that the surface tension of the ink composition used in the present invention is preferably adjusted to a range of 20 mN/m to 60 mN/m, more preferably from 20 mN/m to 45 mN/m, and still more preferably from 25 mN/m to 40 mN/m.

As the surfactant, a compound having a structure including a hydrophilic portion and a hydrophobic portion in the molecule can be favorably used, and any of an anionic surfactant, a cationic surfactant, an amphoteric surfactant and a nonionic surfactant may be used.

Although the content of the surfactant in the ink composition is not specifically restricted, the content is preferably 1% by mass or more, more preferably from 1% by mass to 10% by mass, and further more preferably from 1% by mass to 3% by mass.

Properties of Ink Composition

The surface tension of the ink composition used in the present invention is preferably adjusted to a range of from 20 mN/m to 60 mN/m, more preferably from 20 mN/m to 45 mN/m, and still more preferably from 25 mN/m to 40 mN/m, from the viewpoint of ejection stability when the ink composition is applied to inkjet recording system.

The viscosity of the ink composition used in the present invention at 20° C. is preferably from 1.2 mPa·s to 15.0 mPa·s, more preferably from 2 mPa·s to less than 13 mPa·s and still more preferably from 2.5 mPa·s to less than 10 mPa·s.

The ink composition used in the present invention may be used for formation of multi-color images (for example, full color mages). For the formation of multi-color images, the ink composition may be used as a magenta colored ink, a cyan colored ink, or a yellow colored ink by changing a color hue of the pigment used in the ink composition as requested. Further, in order to adjust a color tone, a black colored ink may be used.

Further, the ink composition used in the present invention may be used as a red (R)-, green (G)-, blue (B)-, or white (W)-colored ink, or a so-called “special color” ink in the graphic art, except for the yellow (Y)-, magenta (M)-, or cyan (C)-colored ink.

Aggregation Liquid

The ink set of the present invention preferably further include at least one aggregation liquid (hereinafter, may be referred to as a reaction liquid) capable of forming an aggregate when the aggregating liquid contacts the ink composition.

The aggregation liquid contains at least one aggregating agent (hereinafter, may be referred to as an aggregation accelerator) capable of forming an aggregate when the aggregating agent contacts the ink composition. Due to mixing of the ink composition and the aggregating agent on a recording medium, aggregation of pigments or the like that is stably existing as a dispersion in the ink composition is accelerated. The aggregating agent is preferably at least one of materials selected from the group consisting of a cationic polymer, an acidic compound and a polyvalent metal salt from the viewpoint of image quality to be formed.

Polymers having a primary-, secondary- or tertiary-amino group or a quaternary ammonium salt group as the cationic group can be preferably used as the cationic polymer.

Preferable examples of the cationic polymer include: polymers that are obtained as a homopolymer of a monomer (cationic monomer) having a primary-, secondary- or tertiary-amino group, salts thereof, or a quaternary ammonium salt group; and polymers that are obtained as a copolymer or a condensation polymer of the cationic monomer and other monomer (hereinafter sometimes referred to as a “non-cationic monomer”). The polymers can be used in any form of a water-soluble polymer or water dispersible latex particles.

Specifically, the cationic polymer may be selected from poly (vinylpyridine) salts, polyalkylaminoethylacrylate, polyalkylaminoethylmethacrylate, poly (vinylimidazole), polyethyleneimine, polybiguanide, polyguanide, a copolymer containing an epihalohydrin derivative and an amine derivative as polymer components, a combination of these polymers, or the like.

The aggregation liquid used in the present invention may contain a water-based solvent (e.g., water) in addition to the cationic polymer.

The content of the cationic polymer in the aggregation liquid is preferably 5% by mass to 95% by mass, and more preferably 10% by mass to 80% by mass with respect to the total amount of the aggregation liquid from the viewpoint of aggregation effects.

Examples of the aggregation liquid containing an acid compound include a liquid that can generate an aggregate by changing the pH of the ink composition. Herein, the pH of the aggregation liquid at 25° C. is preferably 1 to 6, more preferably 2 to 5, and still more preferably 3 to 5 from the viewpoint of the aggregation rate of the ink composition. Herein, the pH of the ink composition used in the ejection process at 25° C. is preferably 7.5 or more, and more preferably 8 or more.

In particular, in preferable embodiments, the pH (25° C.) of the ink composition is 7.5 or more and the pH (25° C.) of the aggregation liquid is 3 to 5 from the viewpoint of improvements in image density and image resolution, and speed up of ink jet recording.

The components for the aggregation can be used singly or in combination of two or more kinds.

The aggregation liquid may be formed using at least one acid compound as an aggregation accelerator. Examples of the acid compound include compounds having a phosphoric acid group, a phosphonic acid group, a phosphinic acid group, a sulfuric acid group, a sulfonic acid group, a sulfinic acid group, or a carboxyl group, or salts thereof (e.g., polyvalent metal salts). Among the above, from the viewpoint of the aggregation rate of the ink composition, the compounds having a phosphoric acid group or a carboxyl group are more preferable, and the compounds having a carboxyl group are still more preferable.

The compounds having a carboxyl group are preferably selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyronecarboxylic acid, pyrrolecarboxylic acid, furancarboxylic acid, pyridinecarboxylic acid, coumalic acid, thiophenecarboxylic acid, nicotinic acid, derivatives thereof, or salts thereof (e.g., polyvalent metal salts). These compounds may be used singly or in combination of two or more thereof.

The content of the acid compound in the aggregation liquid is preferably from 5% by mass to 95% by mass, and more preferably from 10% by mass to 80% by mass, with respect to the total amount of the aggregation liquid from the viewpoint of the aggregation effects.

One preferable example of the aggregation liquid that improves high-speed aggregation properties include an aggregation liquid to which a polyvalent metal salt is added. Examples of the polyvalent metal salt include alkaline earth metals of the second group of the periodic table (e.g., magnesium and calcium), the transition metals of the third group of the periodic table (e.g., lanthanum), cation of the 13th group of the periodic table (e.g., aluminum), and salts of lanthanides (e.g., neodymium). Carboxylate (for example, salts of formic acid, acetic acid, or benzoic acid), nitrate, chloride, and thiocyanate are preferable as the salts of metals. Among the above, calcium salts or magnesium salts of carboxylic acid (for example, salts of formic acid, acetic acid, or benzoic acid), calcium salts or magnesium salts of nitric acid, calcium chloride, magnesium chloride, and calcium salts or magnesium salts of thiocyanic acid are preferable.

The content of the metal salt in the aggregation liquid is preferably in the range of 1% by mass to 10% by mass, more preferably in the range of 1.5% by mass to 7% by mass, and still more preferably in the range of 2% by mass to 6% by mass.

### 2. Maintenance Liquid

The maintenance liquid used in the invention is not particularly limited.

However, in view of the following points, the maintenance liquid preferably contains a water-soluble organic solvent having an SP value of 27.5 or less in an amount of 50% by mass or more of the total content of the water-soluble organic solvents contained in the maintenance liquid.

The ink composition used in the invention contains high-Tg polymer particles having a Tg of 50° C. or more, and is excellent in anti-blocking property. When the ink composition remains and is dried in an inkjet head, the composition firmly adheres thereto and the maintenanceability becomes lowered. Since the urea or urea derivative is contained, the maintenanceability is improved, and when a maintenance liquid containing a water-soluble organic solvent having an SP value of 27.5 or less in an amount of 50% by mass or more of the total content of the water-soluble organic solvents contained in the maintenance liquid is used, the maintenanceability is significantly improved.

The maintenance liquid preferably contains water in addition to the above-described solvents, but other components are not particularly limited. From the viewpoint of improving the removability of the adhering ink on the inkjet head, a pH adjusting agent and a surfactant are preferably further contained, and other additives such as an antifungal agent, an antirust agent, an antiseptic agent, and a viscosity adjustment agent may be optionally used.

The water-soluble organic solvent having an SP value of 27.5 or less is preferably contained in an amount of 50% by mass or more of the total content of the water-soluble organic solvents contained in the maintenance liquid, and from the viewpoint of improving the removability of the adhering ink on the inkjet head, the amount is more preferably 60% by mass or more, further preferably 70% by mass or more, and most preferably 80% by mass or more.

If the amount is less than 50% by mass, the removability of the adhering ink may become insufficient.

The solubility parameter (SP value) of the solvent in the invention is a value represented by the square root of the molecular cohesive energy, and may be calculated by the method described in R. F. Fedors, Polymer Engineering Science, 14, p 147 (1967). Such a value is used in the invention.

Specific examples of the water-soluble organic solvent having an SP value of 27.5 or less used in the maintenance liquid is the same as those exemplified as specific examples that may be contained in the ink composition, and the preferable range thereof is also the same.

Further, in the invention, other additional solvents may be used to the extent that the additional solvents do not impair the effect of the invention. Additional water-soluble organic solvents may be selected from those exemplified as a water-soluble organic solvent that may be contained in the ink composition.

As a penetrating agent, polyol compounds are preferable, and as an aliphatic diol, for example, 2-ethyl-2-methyl-1,3 propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, and 2-ethyl-1,3-hexanediol are exemplified. Among them, 2-ethyl-1,3-hexanediol and 2,2,4-trimethyl-1,3-pentanediol may be exemplified as preferable examples.

The content of the solvent in the entire maintenance liquid is preferably 5% by mass or more, more preferably from 5% by mass to 70% by mass, and further preferably from 10% by mass to 50% by mass, from the viewpoint of improving the removability of the adhering ink.

In the invention, the maintenance liquid preferably contains water. The content of water is not particularly limited. From the viewpoint of stability and convenience, a preferable content of water is from 10% by mass to 99% by mass, more preferably from 30% by mass to 80% by mass, and further preferably from 50% by mass to 70% by mass, with respect to a total mass of the maintenance liquid.

Surfactant

The maintenance liquid in the invention may contain at least one surfactant as a surface tension adjusting agent.

As the surfactant, a nonionic surfactant, a cationic surfactant, an anionic surfactant and a betaine surfactant are exemplified. In order to effectively clean the inkjet head, the addition amount of the surfactant is preferably an amount that adjusts the surface tension of the maintenance liquid in the range of from 20 mN/m to 50 mN/m, more preferably from 20 mN/m to 40 mN/m, and further preferably from 25 mN/m to 35 mN/m.

As the surfactant, a compound having a structure including a hydrophilic portion and a hydrophobic portion in the molecular may be effectively used, and any of an anionic surfactant, a cationic surfactant, an amphoteric surfactant and a nonionic surfactant may be used. Further, the above-described polymer materials (polymer dispersants) may also be used as a surfactant.

Specific examples of the anionic surfactant include sodium dodecyl benzene sulfonate, sodium lauryl sulfate, sodium alkyl diphenyl ether disulfonate, sodium alkyl naphthalene sulfonate, sodium dialkyl sulfosuccinate, sodium stearate, potassium oleate, sodium dioctyl sulfosuccinate, sodium polyoxyethylene alkyl ether sulfate, sodium polyoxyethylene alkyl ether sulfate, sodium polyoxyethylene alkyl phenyl ether sulfate, sodium dialkyl sulfosuccinate, sodium stearate, sodium oleate, sodium t-octyl phenoxy ethoxy polyethoxy ethyl sulfate, and the like, and one or two or more of them may be selected.

Specific examples of the nonionic surfactant include an acetylene diol derivative such as an ethylene oxide adduct of acetylene diol, polyoxyethylene lauryl ether, polyoxyethylene octyl phenyl ether, polyoxyethylene oleyl phenyl ether, polyoxyethylene nonyl phenyl ether, oxyethylene oxypropylene block copolymer, t-octyl phenoxy ethyl polyethoxy ethanol, nonyl phenoxy ethyl polyethoxy ethanol, and the like, and one or two or more of them may be selected.

Examples of the cationic surfactant include a tetraalkyl ammonium salt, an alkylamine salt, a benzalkonium salt, an alkyl pyridinium salt, an imidazolium salt, and the like. Specific examples include dihydroxyethyl stearyl amine, 2-heptadecenyl-hydroxyethyl imidazoline, lauryl dimethyl benzyl ammonium chloride, cetyl pyridinium chloride, stearamide methylpyridinium chloride, and the like.

Among them, from the viewpoint of not causing an aggregating reaction with ink, a nonionic surfactant or an anionic surfactant is preferable. Especially, an acetylene diol derivative, a sodium alkyl carboxylate, or sodium alkyl sulfonate are most preferable.

The content of the surfactant in the maintenance liquid is not particularly limited, but preferably 0.1% by mass or more, more preferably from 0.5% by mass to 10% by mass, and further preferably from 1% by mass to 3% by mass, from the viewpoint of cleaning performance.

Other Components

The maintenance liquid in the invention may contain other additives. Examples of other additives include known additives such as an antifungal agent, a pH adjusting agent, an antirust agent, an antiseptic agent, a viscosity adjusting agent, and the like.

Examples of the antifungal agent include sodium dehydroacetate, sodium benzoate, sodium pyridinethione-1-oxide, p-hydroxybenzoic acid ethyl ester, 1,2-benzisothiazolin-3-on, sodium sorbate, sodium pentachlorophenolate, and the like. These are preferably used in an amount of from 0.02% by mass to 1.00% by mass in the maintenance liquid.

The pH adjusting agent may be appropriately selected according to the purpose without limitation as long as it may adjust the pH of the maintenance liquid to a desired value without impairing the cleaning effect. Examples thereof include alcoholamines (such as diethanolamine, triethanolamine, 2-amino-2-ethyl-1,3-propanediol and the like), alkali metal hydroxides (such as lithium hydroxide, sodium hydroxide, potassium hydroxide and the like), ammonium hydroxides (such as ammonium hydroxide, quaternary ammonium hydroxides and the like), phosphonium hydroxides, alkali metal carbonates and the like.

Examples of the antirust agent include acidic sulfite salts, sodium thiosulfate, ammonium thiodiglycolate, diisopropyl ammonium nitrite, pentaerythritol tetranitrate, dicyclohexyl ammonium nitrite, and the like.

Liquid Properties of Maintenance Liquid

The maintenance liquid in the invention is preferably a liquid that does not cause aggregation when mixed with the ink composition in the invention. This is because if aggregation is caused, components such as pigment in the ink composition adhere to the inkjet head or the like, so that the effect of the invention may be decreased.

The pH of the maintenance liquid in the invention is not particularly limited, but is preferably from 6 to 10 and more preferably form 7 to 9 in view of the inhibition of rusting in the inkjet recording apparatus and the inhibition of deterioration of the liquid-repellent film of the head.

The viscosity at 20° C. of the maintenance liquid of the invention is preferably from 1 mPa·s to 1000 mPa·s, more preferably from 1 mPa·s to less than 500 mPa·s, and further preferably from 2 mPa·s to less than 100 mPa·s, from the viewpoint of workability.

The measurement method of the viscosity of the maintenance liquid is the same as the measurement method described in the section of the aggregating liquid.

The solid content (25° C.) of the maintenance liquid is not particularly limited. However, from the viewpoint of preventing solid residues from being formed after cleaning, the solid content is preferably 5% by mass or less, and more preferable 2% by mass or less.

The maintenance liquid preferably contains water in addition to the above-described solvents, but other components are not particularly limited. From the viewpoint of improving the removability of the adhering ink on the inkjet head, a pH adjusting agent and a surfactant are preferably further contained, and other additives such as an antifungal agent, an antirust agent, an antiseptic agent, and a viscosity adjustment agent may be optionally used.

### 3. Image Formation Method

The image formation method of the invention is a method of forming an image using the above-described ink set. In the invention, the image formation method is not particularly limited as long as the method is a method using the above-described ink set. However, a method including a process of applying the ink composition to a recording medium (ink applying process) and a process of applying the maintenance liquid (maintenance liquid applying process), and further a process of applying the aggregating liquid (aggregating liquid applying process) is preferable. The image formation method of the invention may include other processes (such as a drying and removing process and a heat fixing process) if necessary.

Ink Application Process

Any known liquid application methods can be used without limitation in the ink application process that is performed in the present invention. Examples of the liquid application method include application of ink using a common writing material, application of ink using a pen plotter, and application of ink by an ink jet method. From the viewpoint of high-speed recordability, the application of the ink composition is preferably performed by an inkjet method.

Inkjet recording method which can be used in the present invention may include imparting energy to an inkjet recording ink (ink composition) to form an image on a known image receiving material such as plain paper, resin coated paper, inkjet paper such as those described in JP-A-No. 8-169172, 8-27693, 2-276670, 7-276789, 9-323475, 62-238783, 10-153989, 10-217473, 10-235995, 10-217597 or 10-337947, a film, electrophotographic common paper, fabrics, glass, metal or ceramics. In embodiments, the inkjet recording method described in the paragraphs 0093 to 0105 of JP-A No. 2003-306623 can be used as a preferable inkjet recording method in the present invention.

As the inkjet head (hereinafter simply referred to as “head” in sometimes), a known ink jet head may be used. Either a continuous type head or a dot-on-demand type head can be used. Of dot-on-demand type heads, a head having an operation valve at a thermal head for ejection, such as that disclosed in JP-A No. 9-323420 is preferable. Examples of piezo heads include those described in European Patent Application Publication Nos. 0277703 A1 and 0278590 A1. It is preferable that the head has a temperature adjustment function so that the temperature of the ink may be controlled. In the ink ejection process, it is preferable to control the temperature of the ink so that a deviation of the ink viscosity is within ±5%. It is preferable that operation is performed at a drive frequency from 1 kHz to 500 kHz. It is not necessary for the shape of the nozzle to be circular, and any shape, such as an elliptical or square shape, may be used. It is preferable that the nozzle diameter is within a range of from 10 μm to 100 μm. Further, it is not necessary for the nozzle opening portions themselves to be perfectly circular. If they are not perfectly circular, then the term “nozzle diameter” indicates the diameter of a circle having the same area as the area of the nozzle opening portion.

In the ink ejection process, to adjust the temperature of the ink at the time of ejection and to improve wiping properties, the temperature of the ink at the time of ejection is preferably 30° C. or more, and more preferably 35° C. or more. For ink stability and ejection reliability, the temperature of the ink is preferably 70° C. or less.

In order to reduce ink adhesion, it is preferable that the surface of the nozzles is treated with an ink-repellant. By coating the nozzles with a perfluoro polymer such as PTFE, PFA or FEP, a particularly excellent liquid repellent function can be obtained.

Ink Removal Process

In the ink removal process, a maintenance liquid is applied to an inkjet head (for example, a vicinity of the head, an ink flow path, and the like, hereinafter referred to as “a head and the like”) in order to remove an ink or a solidified ink fouling from a nozzle surface of a head. The application of the maintenance liquid to the head and the like may make, a solidified ink originated from the ink on a nozzle surface, easier to be dissolved or swelled whereby the solidified ink can be easily removed.

Substances derived from solidified ink may be removed by scraping with a blade or wiping with a cloth or paper before or after applying the maintenance liquid. Preferable examples of the method of removing a solidified ink fouling include: scraping off of solidified ink by abrading (wiping) a nozzle head with a wiper blade after applying a maintenance liquid; and removal of solidified ink by air pressure or liquid pressure of a maintenance liquid or the like; and wiping with a cloth or paper. In particular, scraping with a blade or wiping with a cloth or paper is preferable.

The material of the wiper blade is preferably an elastic rubber. Specific examples of the material include butyl rubber, chloroprene rubber, ethylene propylene rubber, silicone rubber, urethane rubber, and nitrile rubber. A wiper blade coated with a fluorine resin or the like for imparting ink repellency may be used.

Since the specific ink composition described above is used in the image forming method of the present invention, a solidified ink fouling originated from an ink composition on a nozzle surface can be easily scraped off as a solid.

After forming an image by ejecting an ink onto a recording medium in an ink application process, the image forming method of the present invention may further include a process of fixing an image by heating the recording medium (thermal fixing process).

A method of drying and removing an ink solvent is not particularly limited, as long as the method can dry and remove the ink solvent (water or a solvent) included in an ink composition ejected onto the recording medium, and may be appropriately selected according to the desired purpose.

The method of the thermal fixing is not particularly limited as long as the method can soften polymer particles included in an ink composition and impart rubbing resistance to an image, and may be appropriately selected according to the desired purpose.

The recording medium used in the present invention is not particularly limited, and specific examples thereof include plain paper, bond paper, coated paper and the like.

Aggregation Liquid Application Process

In the aggregation liquid application process, it is preferable to provide a process of applying, onto a recording medium, an aggregation liquid containing an aggregating agent capable of forming an aggregate when the aggregation liquid contacts the already described ink composition before or after the already described ink application process using the ink composition so that an image can be formed by the contact of the ink composition with the aggregation liquid.

In the present invention, it is preferred to apply an ink composition onto an image recording medium after the application of the aggregation liquid. In other words, in preferable embodiments, the aggregation liquid for aggregating particles of pigment or the like included in the ink composition is applied on the recording medium in advance of applying the ink composition, and then the ink composition is applied so that it contacts an aggregation system which is formed by the aggregation liquid on the recording medium, thereby forming an image. As a result, the speed up of inkjet recording can be achieved, and an image having a high density and high resolution can be obtained even when recording is performed at a high speed.

In the ink jet recording method of the present invention, it is possible to use an intermediate transfer body as an a recording medium on which an image is to be recorded at first. Namely, in this embodiment, the ink jet recording method may include: a process of applying, onto an intermediate transfer body, the ink composition used in the invention, by an inkjet method; a process of applying, onto the intermediate transfer body, an aggregation liquid capable of forming a coagulate on the intermediate transfer body when the aggregation liquid contacts the ink composition, so that the ink composition and the aggregation liquid are brought into contact with each other to form an image on the intermediate transfer body; and a process of transferring the thus-formed image on the intermediate transfer body to a desired recording medium as a final recorded media. Also in this embodiment, it is preferred that the ejection of the ink composition is performed after the application of the aggregation liquid.

An image is recorded using the ink composition or the ink set according to the present invention, whereby the image-recorded matter having a suppressed curl can be obtained.

### EXAMPLES

Hereinafter, the present invention will be described in more detail with reference to the following examples, although the present invention is not limited to these examples. “Parts” and “%” indicate quantities in terms of weight, unless otherwise specified.

The weight average molecular weight was herein measured by gel permeation chromatography (GPC). In the GPC, the measurement was carried out by the use of HLC-8020GPC (trade name, manufactured by Tosoh Corporation), three columns of TSK GEL, SUPER MULTIPORE HZ-H (trade name, manufactured by Tosoh Corporation; 4.6 mmID×15 cm), and THF (tetrahydrofuran) as an elute.

The measurement was carried out using an RI detector under the conditions of a sample concentration of 0.35% by mass, a flow rate of 0.35 ml/min, a sample injection amount of 10 μl, and a measurement temperature of 40° C. The calibration curve was prepared from eight standard samples “TSK Standard Polystyrene”: “F-40”, “F-20”, “F-4”, “F-1”, “A-5000”, “A-2500”, “A-1000” and “n-propylbenzene” (trade names, manufactured by Tosoh Corporation). The measurement of the surface tension was carried out under the condition of 25° C. using Automatic Surface Tensiometer CBVP-Z (trade name, manufactured by Kyowa Interface Science Co., Ltd.) in accordance with the Wilhelmy method using a platinum plate. The measurement of the viscosity was carried out under the condition of 30° C. using VISCOMETER TV-22 (trade name, manufactured by Toki Sangyo Co., Ltd). The measurement of pH was carried out under the condition of 25° C.±1° C. using a pH meter WM-50EG (trade name, manufactured by DKK-TOA Corporation).

Materials used in Examples were prepared as described below.

Preparation of Polymer Particles

Preparation of Self-Dispersible Polymer Particles A-01

560.0 g of methyl ethyl ketone was placed in a 2 L three necked flask equipped with a stirrer, a thermometer, a reflux condenser tube, and a nitrogen gas introducing tube, and the temperature outside a reactor was raised to 87° C. Thereafter, while maintaining a reflux state in the reactor (hereinafter, reflux was continued till the end of the reaction), a mixed solution containing 429.2 g of methyl methacrylate, 87.0 g of benzylmethacrylate, 29.0 g of “PME-1000” (trade name, manufactured by NOF CORPORATION, methoxypolyethyleneglycol methacrylate (n=23)), 34.8 g of methacrylic acid, 108 g of methyl ethyl ketone, and 2.32 g of V-601 (trade name, manufactured by Wako Pure Chemical Ind. Ltd.) was added dropwise at a constant rate so that the dropwise addition was completed in 2 hours. After completion of the dropping, the mixed solution was stirred for 1 hour. Then, (1) a solution containing 1.16 g of V-601 (described above) and 6.4 g of methyl ethyl ketone was added, and stirred for 2 hours. Subsequently, the process (1) was repeated four times. Further, a solution containing 1.16 g of V-601 (described above) and 6.4 g of methyl ethyl ketone was added, and stirred for 3 hours, thereby obtaining a resin solution of a methyl methacrylate/benzylmethacrylate/PME-1000/methacrylic acid (=74/15/5/6 [mass ratio]) copolymer.

The weight average molecular weight (Mw) of the obtained copolymer was 63,000 (calculated by gel permeation chromatography (GPC) in terms of polystyrene) and the acid value was 39 (mgKOH/g). Further, the glass transition temperature (Tg) was 102° C.

Next, 291.5 g of the obtained resin solution (solid concentration: 44.6%) was weighed, and 82.5 g of isopropanol and 50.82 g of aqueous 1 mol/L NaOH solution were added thereto. Then, the temperature inside the reactor was raised to 87° C. Next, 364 g of distilled water was added dropwise thereto at a rate of 10 ml/min, and the copolymer resin was dispersed in water. Thereafter, the resultant mixture was held under an atmospheric pressure at a temperature inside the reactor of 87° C. for 1 hour, at 91° C. for 1 hour, and at 95° C. for 30 minutes. Then, the pressure inside the reactor was reduced so that a total of 309.4 g of isopropanol, methylethylketone and distilled water was distilled away, thereby obtaining a water dispersion (emulsion) of a self-dispersible polymer particles A-01 having a solid concentration of 26.5% by mass.

Preparation of Self-Dispersible Polymer Particles A-02

360.0 g of methyl ethyl ketone was placed in a 2 L three necked flask equipped with a stirrer, a thermometer, a reflux condenser tube, and a nitrogen gas introducing pipe, and the temperature was raised to 75° C. Thereafter, a mixed solution containing 180.0 g of methyl methacrylate, 32.4 g of methoxyethyl acrylate, 126.0 g of benzyl methacrylate, 21.6 g of methacrylic acid, 72 g of methyl ethyl ketone, and 1.44 g of V-601 (trade name, manufactured by Wako Pure Chemical Industries, Ltd.) was added dropwise thereto at a constant rate so that the dropwise addition was completed in 2 hours. After completion of the dropping, a solution containing 0.72 g of V-601 and 36.0 g of methyl ethyl ketone was added thereto, and stirred at 75° C. for 2 hours. Further, a solution containing 0.72 g of V-601 and 36.0 g of methyl ethyl ketone was added thereto, and stirred at 75° C. for 2 hours. Thereafter, the temperature was raised to 85° C., and the stirring was continued for further 2 hours, thereby obtaining a resin solution of a methyl methacrylate/methoxyethyl acrylate/benzyl methacrylate/methacrylic acid (=50/9/35/6 [mass ratio]) copolymer.

The weight average molecular weight (Mw) of the obtained copolymer was 66,000 (determined by gel permeation chromatography (GPC) and polystyrene conversion), the acid value thereof was 39 (mgKOH/g), and the glass transition temperature (Tg) thereof was 78° C.

Next, 668.3 g of the obtained resin solution was weighed, and 388.3 g of isopropanol and 145.7 ml of aqueous 1 mol/L NaOH solution were added. Then, the temperature inside the reactor was raised to 80° C. Next, 720.1 g of distilled water was added dropwise at a rate of 20 ml/min so that the copolymer resin is dispersed in water. Thereafter, the resultant was held under an atmospheric pressure at a temperature inside the reactor of 80° C. for 2 hours, and then maintained at 85° C. for 2 hours, and then further maintained at 90° C. for 2 hours. Then, the pressure inside the reactor was reduced, and the isopropanol, methyl ethyl ketone, and distilled water were distilled off in the total amount of 913.7 g, thereby obtaining water dispersion (emulsion) of the self-dispersible polymer particles A-02 having a solid content of 28.0% by mass.

Preparation of Self-Dispersible Polymer Particles A-03

360.0 g of methyl ethyl ketone was placed in a 2 L three necked flask equipped with a stirrer, a thermometer, a reflux condenser tube, and a nitrogen gas introducing pipe, and the temperature was raised to 75° C. Thereafter, while maintaining the temperature inside the flask at 75° C., a mixed solution containing 180.0 g of phenoxyethyl acrylate, 162.0 g of methyl methacrylate, 18.0 g of acrylic acid, 72 g of methyl ethyl ketone, and 1.44 g of V-601 (trade name, manufactured by Wako Pure Chemical Industries, Ltd.) was added dropwise thereto at a constant rate so that the dropwise addition was completed in 2 hours. After completion of the dropping, a solution containing 0.72 g of V-601 and 36.0 g of methyl ethyl ketone was added thereto, and stirred at 75° C. for 2 hours. Further, a solution containing 0.72 g of V-601 and 36.0 g of isopropanol was added thereto, and stirred at 75° C. for 2 hours. Thereafter, the temperature was raised to 85° C., and the stirring was continued for further 2 hours, thereby obtaining a resin solution of a phenoxy ethyl acrylate/methyl methacrylate/acrylic acid (=50/45/5 [mass ratio]) copolymer.

The weight average molecular weight (Mw) of the obtained copolymer was 64,000 (determined by gel permeation chromatography (GPC) and polystyrene conversion), the acid value thereof was 38.9 (mgKOH/g), and the glass transition temperature (Tg) thereof was 43° C.

Next, 668.3 g of the obtained resin solution was weighed, and 388.3 g of isopropanol and 145.7 ml of aqueous 1 mol/L NaOH solution were added thereto. Then, the temperature inside the reactor was raised to 80° C. Next, 720.1 g of distilled water was added dropwise thereto at a rate of 20 ml/min, and the copolymer resin was dispersed in water. Thereafter, the resultant mixture was held under an atmospheric pressure at a temperature inside the reactor of 80° C. for 2 hours, at 85° C. for 2 hours, and at 90° C. for 2 hours. Then, the pressure inside the reactor was reduced so that a total of 913.7 g of isopropanol, methylethylketone and distilled water was distilled away, thereby obtaining a water dispersion (emulsion) of a self-dispersible polymer particles A-03 having a solid concentration of 28.0% by mass.

Synthesis of Water-Insoluble Resin Dispersant P-1

Water-insoluble resin dispersant P-1 was synthesized in accordance with the following scheme.

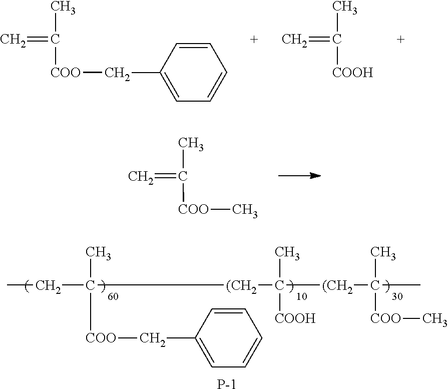

Methyl ethyl ketone (88 g) was placed in a 1000 ml three-necked flask equipped with a stirrer and a condenser tube, and heated to 72° C. under a nitrogen atmosphere. Separately, 0.85 g of dimethyl-2,2′-azobisisobutyrate, 60 g of benzyl methacrylate, 10 g of methacrylic acid, and 30 g of methyl methacrylate were dissolved in 50 g of methyl ethyl ketone to form a solution. The solution was added dropwise to the liquid in the flask over three hours. After the dropwise addition was completed, the reaction was further continued for one hour. Then, a solution obtained by dissolving 0.42 g of dimethyl-2,2′-azobisisobutyrate in 2 g of methyl ethyl ketone was added to the reaction solution, and the reaction solution was heated to 78° C. and heated at this temperature for 4 hours. The obtained reaction solution was reprecipitated twice with an excess quantity of hexane, and the precipitated resin was dried to obtain 96 g of the resin dispersant P-1.

The formulation of the obtained resin was identified with ¹H-NMR. The weight average molecular weight (Mw) was determined by a GPC method, and was found to be 44,600. Furthermore, the acid value of the polymer was obtained in accordance with the method described in JIS Standard (JIS-K0070 (1992) and was found to be 65.2 mgKOH/g.

(Preparation of Yellow Pigment Dispersion Y)

10 parts by mass of pigment yellow 74 (Irgalite Yellow GS, trade name, manufactured by BASF Japan Ltd.), 5 parts by mass of the water-insoluble resin dispersant P-1, 42 parts by mass of methyl ethyl ketone, 5.5 parts by mass of aqueous 1N NaOH solution, and 87.2 parts by mass of ion exchange water were mixed, and dispersed with a bead mill using 0.1 mm Φ zirconia beads for 2 to 6 hours.

The methyl ethyl ketone and a part of the water were removed from the obtained dispersion under a reduce pressure at 55° C., whereby a yellow pigment resin dispersion having a pigment concentration of 10.2% by mass was obtained.

(Preparation of Magenta Pigment Dispersion M)

A magenta pigment resin dispersion having a pigment concentration of 10.2% by mass was obtained in the same manner as in the preparation of the yellow pigment dispersion Y, except that pigment red 122 (Jet Magenta DMQ, trade name, manufactured by BASF Japan Ltd.) was used in place of pigment yellow 74.

(Preparation of Cyan Pigment Dispersion C)

A cyan pigment resin dispersion having a pigment concentration of 10.2% by mass was obtained in the same manner as in the preparation of the yellow pigment dispersion Y, except that pigment blue 15:3 (Phthalocyanine Blue A220, trade name, manufactured by Dainichiseika Color & Chemicals Mfg. Co., Ltd.) was used in place of pigment yellow 74.

(Preparation of Black Pigment Dispersion K)

A black pigment resin dispersion having a pigment concentration of 10.2% by mass was obtained in the same manner as in the preparation of the yellow pigment dispersion Y, except that carbon black (NIPEX 180-IQ, trade name, manufactured by Degussa Japan Co., Ltd.) was used in place of pigment yellow 74.

(Water-Soluble Organic Solvent)
SANNIX GP250 (trade name, manufactured by Sanyo Chemical Industries, Ltd., an oxypropylene glyceryl ether represented by the following structural formula, SP value=26.4)

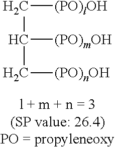

SANNIX GP400 (trade name, manufactured by Sanyo Chemical Industries, Ltd., a compound represented by the above structural formula in which l+m+n=6, SP value=23.2)
TPGmME: tripropylene glycol monomethyl ether (manufactured by Wako Pure Chemical Industries, Ltd., SP value=20.4)
DEGmEE: diethylene glycol monoethyl ether (SP value=22.4)
Glycerol (SP value=41.0)
DEGmBE: diethylene glycol monobutyl ether (manufactured by Wako Pure Chemical Industries, Ltd., SP value=21.5)

### Example 1

### 1. Preparation of Ink Composition

Using the above-obtained cyan pigment dispersion liquid and a dispersion of self-dispersing polymer particles, ingredients incorporated therein were mixed so as to be the following percentage composition, thereby preparing a water-based ink. The water-based ink obtained above was packed in a plastic disposable syringe, and then filtrated through a polyvinylidene fluoride (PVDE) filter having pore sizes of 5 μm (MILLEX-SV, manufactured by Millipore Corporate, diameter of 25 mm). Thus, a finished ink was prepared.

| | |
|---|---|
| Cyan pigment (Pigment blue 15:3) | 2.5% |
| Water-insoluble polymer dispersant p-1 | 1.25% |
| Aqueous dispersion of self-dispersible | 8.0% |
| polymer particles A-01 (solid content) | |
| Urea | 5.0% |
| SANNIX GP 250 (SP value = 26.4) | 8.0% |
| TPGmME (SP value = 20.4) | 8.0% |
| OLFINE E1010 (trade name, manufactured | 1.0% |
| by Nissin Chemical Industry Co., Ltd. | |
| surfactant) | |
| Ion exchange water | 66.25% |

The pH of the ink composition (undiluted solution) was adjusted to 8.3.

When the viscosity, surface tension, and pH (at 25±1° C.) of the obtained cyan pigment ink composition were measured, the viscosity was 4.8 mPa·s, the surface tension was 35.4 mN/m, and the pH was 8.5.

The measurement of the viscosity was carried out under the condition of 20° C. using VISCOMETER TV-22 (trade name, manufactured by Toki Sangyo Co., Ltd). The measurement of the surface tension was carried out under the condition of 25° C. using Automatic Surface Tensiometer CBVP-Z (trade name, manufactured by Kyowa Interface Science Co., Ltd.). The measurement of pH was carried out under the condition of 25° C.±1° C.

### 2. Preparation of Aggregation Liquid

Components shown in the following formulation was mixed to prepare an aggregation liquid. The viscosity, surface tension, and pH (25±1° C.) of the aggregation liquid were measured to turn out to be 4.9 mPa·s, 24.3 mN/m, and 1.5, respectively. The measurement of the viscosity, surface tension, and pH were performed in the same manner as mentioned above.

Formulation of Aggregation Liquid

| | |
|---|---|
| Dimethylamine/Epichlorohydrin copolymer | 5% by mass |
| (Polymerization ratio 1:1, Weight average | |
| molecular weight 6000) | |
| Diethyleneglycol monoethylether (a product of | 20.0% by mass |
| Wako Pure Chemical Ind. Ltd.) | |
| ZONYL FSN-100 (trade name, manufactured by | 1.0% by mass |
| DuPont) | |
| Ion exchange water | 74% by mass |

### 3. Preparation of Maintenance Liquid

A maintenance liquid having the following composition was prepared.

When the viscosity, surface tension, and pH (at 25±1° C.) of the maintenance liquid were measured in accordance with the above-described methods, the viscosity was 2.8 mPa·s, the surface tension was 31.6 mN/m, and the pH was 8.3.

The measurement of the viscosity, surface tension, and pH were performed in the same manner as mentioned above.

Composition of Maintenance Liquid A

| | |
|---|---|
| DEGmBE (SP value = 21.5) | 25.0% by mass |
| Sodium oleate (manufactured by Wako | 1% by mass |
| Pure Chemical Industries, Ltd., surfactant) | |
| Ion exchange water | 74% by mass |

### Examples 2 to 4 and Comparative Examples 1 to 2

Preparation of Ink Composition

Each of the aqueous inks was prepared in the same manner as in the preparation of the cyan pigment ink composition, except that the pigment dispersion and the self-dispersible polymer particles were changed so that the following ink composition was obtained. The obtained aqueous ink was charged in a disposable plastic syringe, and filtered through a polyvinylidene fluoride (PVDF) filter having a pore diameter of 5 μm (Millex-SV, trade name, manufactured by Nihon Millipore K.K., diameter: 25 mm) to obtain a completed ink.

Magenta pigment Ink Composition

| | |
|---|---|
| Magenta pigment (pigment red 122) | 5.0% by mass |
| Water-insoluble resin dispersant P-1 | 2.5% by mass |
| Water dispersion of self-dispersible | 7.0% by mass |
| polymer particles A-01 (solid content) | |
| Methyl urea | 5.0% by mass |
| SANNIX GP400 | 10.0% by mass |
| DEGmEE | 5.0% by mass |
| OLFINE E1010 (trade name, manufactured | 1.0% by mass |
| by Nissin Chemical Industry Co., Ltd., | |
| surfactant) | |
| Ion exchange water | 64.5% by mass |

The pH of the ink composition (original liquid) was 8.3.

Yellow Pigment Ink Composition

| | |
|---|---|
| Yellow pigment | 4.0% by mass |
| Water-insoluble resin dispersant P-1 | 2.0% by mass |
| Water dispersion of self-dispersible | 7.0% by mass |
| polymer particles A-01 (solid content) | |
| Urea | 2.5% by mass |
| SANNIX GP250 | 8.0% by mass |
| TPGmME | 8.0% by mass |
| OLFINE E1010 (trade name, manufactured | 1.0% by mass |
| by Nissin Chemical Industry Co., Ltd., | |
| surfactant) | |
| Ion exchange water | 67.5% by mass |

The pH of the ink composition (original liquid) was 8.3.

Black Pigment Ink Composition

| | |
|---|---|
| Black pigment (carbon black) | 4.0% by mass |
| Water-insoluble resin dispersant P-1 | 2.0% by mass |
| Water dispersion of self-dispersible | 6.0% by mass |
| polymer particles A-02 (solid content) | |
| Urea | 10.0% by mass |
| SANNIX GP250 | 10.0% by mass |
| TPGmME | 6.0% by mass |
| OLFINE E1010 (trade name, manufactured | 1.0% by mass |
| by Nissin Chemical Industry Co., Ltd., | |
| surfactant) | |
| Ion exchange water | 61.0% by mass |

The pH of the ink composition (original liquid) was 8.3.

Comparative Cyan Pigment Ink Composition A

| | |
|---|---|
| Cyan pigment (pigment blue 15:3) | 2.5% by mass |
| Above-described water-insoluble resin (solid | 1.25% by mass |
| content) | |
| Above-described water dispersion of self- | 8.0% by mass |
| dispersible polymer particles A-03 (solid | |
| content) | |
| Urea | 5.0% by mass |
| Glycerol | 10.0% by mass |
| OLFINE E1010 (trade name, manufactured by | 1.0% by mass |
| Nissin Chemical Industry Co., Ltd., | |
| surfactant) | |
| Ion exchange water | 72.25% by mass |

The pH of the ink composition (original liquid) was 8.3.

Comparative Cyan Pigment Ink Composition B

| | |
|---|---|
| Cyan pigment (pigment blue 15:3) | 2.5% by mass |
| Above-described water-insoluble resin (solid | 1.25% by mass |
| content) | |
| Above-described water dispersion of self- | 8.0% by mass |
| dispersible polymer particles A-01 (solid | |
| content) | |
| SANNIX GP250 | 8.0% by mass |
| TPGmME | 8.0% by mass |
| OLFINE E1010 (trade name, manufactured by | 1.0% by mass |
| Nissin Chemical Industry Co., Ltd., | |
| surfactant) | |
| Ion exchange water | 71.25% by mass |

The pH of the ink composition (original liquid) was 8.3.

Preparation of Maintenance Liquid

A maintenance liquid having the following composition was prepared.

Composition of Maintenance Liquid B

| | |
|---|---|
| TPGmME | 20.0% by mass |
| Sodium oleate (manufactured by Wako | 1% by mass |
| Pure Chemical Industries, Ltd., surfactant) | |
| Ion exchange water | 79% by mass |

Image Formation and Evaluation

The above obtained ink compositions, aggregation liquid, and maintenance liquids were combined as shown in Table 1 to obtain ink sets of Examples 1 to 4 and Comparative Examples 1 to 2.

In Table 1, the numerical values of the respective components indicate the contents (% by mass).

As a recording medium, TOKUBISHI ART RYOMEN N (trade name, manufactured by Mitsubishi Paper Mills Limited., 84.9 g/m²) was fixed on a stage that was movable in a predetermined linear direction at 500 mm/sec, and an aggregation liquid was applied thereto with a wire bar coater so as to have a thickness of about 5 μm, and dried at 50° C. for 2 seconds immediately after the application of the liquid.

As an inkjet recording apparatus, an inkjet printer prepared by modifying a GELJET GX5000 printer (trade name, manufactured by Ricoh Company, Ltd.) was used, and continuous jetting of an ink composition was carried out for 60 minutes in a droplet amount of 3.5 pL and an ink application amount of 5 g/m² to print a solid image, and suspended for 10 minutes after the jetting.

After the suspension, a maintenance liquid was applied to the nozzle surface of the inkjet head with a roller, the nozzle surface was wiped with a wire blade (hydrogenated NBR), and then continuous jetting of the ink composition for 60 minutes was carried out again to print a solid image.

Next, the recording medium to which the ink had been applied was dried under the following conditions.
Drying method: air sending drying
Wind speed: 15 m/s
Temperature: Heating was carried out with a contact-type flat heater from the side (back side) of the recording medium opposite to the recording surface side thereof so that the surface temperature of the recording surface side of the recording medium was 60° C.).
Air sending region: 640 mm (drying time: 1 second)

Next, heating fixing treatment was carried out by passing through a pair of rollers under the following conditions.
Silicone rubber roller (hardness: 50°, nip width: 5 mm)
Roller temperature: 75° C.
Pressure: 0.8 MPa

The printed matter obtained by the above processes was referred to as an “evaluation sample”. As described below, an evaluation sample was used, or an appropriate printed matter was separately prepared, to carry out evaluations. The evaluation results are shown in Table 1 below.

[High-Speed Printing Suitability]

With respect to the evaluation sample, the ratio of “number of sheets on which unevenness occurred”/“total number of printed sheets” was calculated as a ratio of occurrence of unevenness.

In this case, the printed surface of the evaluation sample was divided into nine sections (3(length direction)×3(width direction)=9), and the color of the central part of each of the nine sections was measured with a colorimeter SpectroEye (trade name, manufactured by X-Rite, Inc.), and a case in which the color variation (3σ) from the average value was 3 or more in terms of ΔE was regarded as a case in which unevenness occurred.

### Evaluation Criteria

A: The ratio of occurrence of unevenness was less than 0.5%.
B: The ratio of occurrence of unevenness was from 0.5% to less than 1%.
C: The ratio of occurrence of unevenness was from 1% to less than 5%.
D: The ratio of occurrence of unevenness was 5% or more.

Jetting Stability

The continuous jetting for 60 minutes, suspension for 10 minutes and wiping operation were repeated 5 times, and then a parallel line pattern of line images of 75×2400 dpi was printed at a jetting frequency of 12 kHz using the 96 nozzles of the inkjet printer. Using a dot analyzer DA-6000 (trade name, manufactured by Oji Scientific Instruments), the central position in the line width was measured with respect to each of the lines, and the standard deviation a with respect to the shift amount between the ideal central position and the measured central position was calculated.

### Evaluation Criteria

### A: σ<2 μm

B: 2 μm≦σ<3 μm
C: 3 μm≦σ<6 μm
D: 6 μm≦σ

Rubbing Resistance

The evaluation sample was rubbed three times (three reciprocating motions) with a paperweight (weight: 470 g, size: 15 mm×30 mm×120 mm) wrapped with the above-described TOKUBISHI ART RYOMEN N which had been cut to the size of 10 mm×50 mm and not printed. This corresponded to a load of 260 kg/m², and the area where the unprinted TOKUBISHI ART RYOMEN N and the evaluation sample contacted each other was 150 mm². The printed surface after rubbing was visually observed, and evaluated in accordance with the following evaluation criteria.

### Evaluation Criteria

A: Peeling of the image (coloring material) was not visually observed at all on the printed surface (no peeling of the printed matter was observed, and no coloring was observed on the unprinted paper).
B: Peeling of the image (coloring material) was hardly visually observed on the printed surface (no peeling of the printed matter was observed, but slight coloring was observed on the unprinted paper).
C: Peeling of the image (coloring material) partially occurred on the printed surface (peeing occurred in 5% or less of the rubbed area on the printed matter).
D: Peeling of the image (coloring material) occurred on the whole of the printed surface (peeing occurred in more than 5% of the rubbed area on the printed matter).

Anti-Blocking Property

The evaluation sample was cut to the size of 3.5 cm×4 cm and placed on an acrylic plate having a size of 10 cm×10 cm so that the printed surface thereof faced upward. Further, on the above evaluation sample, a similarly printed sample was placed so that the printed surface thereof faced downward, whereby the printed surfaces contacted each other. Further, an acrylic plate having a size of 10 cm×10 cm was place thereon, and left under the conditions of 60° C. and 40% RH for 10 hours. After that, 1 kg of weigh was place on the uppermost acrylic plate, and further left for 24 hours (which corresponded to a load of about 700 kg/m²). Subsequently, after being stored under the conditions of 25° C. and 50% RH for 2 hours, the evaluation sample was peeled. At this time, the easiness of peeling and the color transfer after peeling were visually observed, and evaluated in accordance with the following evaluation criteria.

### Evaluation Criteria

A: The evaluation sample was peeled naturally, and no color transfer was observed between the paper samples.
B: Sticking occurred between the paper samples, and slight color transfer was observed between the paper samples.
C: Strong sticking occurred between the paper samples, a lot of color transfer was observed between the paper samples, and the practicality was low.
D: Very strong sticking occurred between the paper samples, peeing was difficult, and the practicality was very low.

As is shown in Table 1, the ink compositions of Examples 1 to 4 were excellent in high-speed printing suitability and long term jetting stability. Further, the obtained printed images were excellent in rubbing resistance and anti-blocking property. In contrast, in Comparative Example 1, occurrence of unevenness was increased at high-speed printing, the jetting stability was lowered, and in a case in which continuous printing was repeatedly carried out, the landing position of the jetted ink became shifted. Further, the anti-blocking property was also lowered. In Comparative Example 2, the jetting stability was significantly lowered, and in a case in which continuous printing was repeatedly carried out, the landing position of the jetted ink became significantly shifted.

All publications, patent applications, and technical standards mentioned in this specification are herein incorporated by reference to the same extent as if each individual publication, patent applications, or technical standards was specifically and individually indicated to be incorporated by reference.

TABLE 1

| | | | | | | | | Evaluation results | | | |
|---|---|---|---|---|---|---|---|---|---|---|---|
| | | | Ink | | | | | | Anti- | | High-speed |
| | Pigment | | | | Polymer particles | | Maintenance | Rubbing | blocking | Jetting | printing |
| | Color | Amount | Solvent | Additive | Amount | Tg (° C.) | liquid | resistance | property | stability | suitability |
| Example 1 | C | 2.5% | GP250 | Urea | 8.0% | 102 | DEGmBE | A | A | A | A |
| | | | 8.0% | 5.0% | | | 25.0% | | | | |
| | | | TPGmME | | | | | | | | |
| | | | 8.0% | | | | | | | | |
| Example 2 | M | 5.0% | GP400 | Methyl urea | 7.0% | 102 | DEGmBE | A | A | A | A |
| | | | 10.0% | 5.0% | | | 25.0% | | | | |
| | | | DEGmEE | | | | | | | | |
| | | | 5.0% | | | | | | | | |
| Example 3 | Y | 4.0% | GP250 | Urea | 7.0% | 102 | DEGmBE | A | A | B | A |
| | | | 8.0% | 2.5% | | | 25.0% | | | | |
| | | | TPGmME | | | | | | | | |
| | | | 8.0% | | | | | | | | |
| Example 4 | K | 4.0% | GP250 | Urea | 6.0% | 78 | TPGmME | A | B | A | A |
| | | | 10.0% | 10.0% | | | 20.0% | | | | |
| | | | TPGmME | | | | | | | | |
| | | | 6.0% | | | | | | | | |
| Comparative | C | 2.5% | Glycerol | Urea | 8.0% | 43 | None | B | D | C | C |
| Example 1 | | | 10.0% | 5.0% | | | | | | | |
| Comparative | C | 2.5% | GP250 | None | 8.0% | 102 | None | A | A | D | A |
| Example 2 | | | 8.0% | | | | | | | | |
| | | | TPGmME | | | | | | | | |
| | | | 8.0% | | | | | | | | |

What is claimed is:

1. An ink set comprising an ink composition and a maintenance liquid, wherein the ink composition comprises a pigment, polymer particles having a glass transition temperature (Tg) of 50° C. or higher, and at least one of urea or a urea derivative.

2. The ink set according to claim 1, wherein the pigment is coated with a water-insoluble resin by a phase inversion emulsification method.

3. The ink set according to claim 1, wherein the polymer particles are self-dispersible polymer particles.

4. The ink set according to claim 1, wherein the polymer particles have a glass transition temperature (Tg) of from 50° C. to 200° C.

5. The ink set according to claim 2, wherein a solid content mass ratio of the pigment with respect to a total mass of the water-insoluble resin and the polymer particles (the pigment/(the water-insoluble resin+the polymer particles) in the ink composition) is 1 or less.

6. The ink set according to claim 3, wherein the self-dispersible polymer particles comprise a water-insoluble polymer comprising a hydrophilic structural unit, and, as a hydrophobic structural unit, a structural unit derived from an aromatic group-containing monomer.

7. The ink set according to claim 6, wherein the hydrophilic structural unit of the water-insoluble polymer is derived from a hydrophilic group-containing monomer, wherein the hydrophilic group is a dissociating group.

8. The ink set according to claim 1, wherein the ink composition further comprises a water-soluble organic solvent and water, and 70% by mass or more of the water-soluble organic solvent is a water-soluble organic solvent having an SP value of 27.5 or less.

9. The ink set according to claim 8, wherein the water-soluble organic solvent added to the ink composition is selected from alkanediols or polyhydric alcohols, alkyl alcohols having 1-4 carbon atoms, glycol ethers, alkylene oxide adducts of glycerol, 2-pyrrolidone, N-methyl-2-pyrrolidone, 1,3-dimethyl-2-imidazolizinone, formamide, acetamide, dimethylsulfoxide, sorbit, sorbitan, acetin, diacetin, triacetin, or sulfolane.

10. The ink set according to claim 1, wherein a total content of the urea and the urea derivative in the ink composition is from 1.0% by mass to less than 20.0% by mass.

11. The ink set according to claim 1, wherein the maintenance liquid includes a water-soluble organic solvent and water, and 50% by mass or more of the water-soluble organic solvent is a water-soluble organic solvent having an SP value of 27.5 or less.

12. The ink set according to claim 11, wherein the water-soluble organic solvent added to the maintenance liquid is selected from alkanediols or polyhydric alcohols, alkyl alcohols having 1-4 carbon atoms, glycol ethers, alkylene oxide adducts of glyceol, 2-pyrrolidone, N-methyl-2-pyrrolidone, 1,3-dimethyl-2-imidazolizinone, formamide, acetamide, dimethylsulfoxide, sorbit, sorbitan, acetin, diacetin, triacetin, or sulfolane.

13. The ink set according to claim 1, wherein the maintenance liquid further comprises a surfactant.

14. The ink set according to claim 1, further comprising an aggregation liquid comprising an aggregating agent that aggregates components in the ink composition.

15. An image formation method comprising:
providing the ink set according to claim 1;
jetting the ink composition from an inkjet head to apply the ink composition to a recording medium; and
removing the ink composition adhering to the inkjet head with the maintenance liquid.

16. The image formation method according to claim 15, further comprising applying an aggregation liquid to the recording medium, wherein the aggregation liquid comprises an aggregating agent that aggregates components in the ink composition.
